(19) United States
(12) Patent Application Publication
(10) Pub. No.: US 2026/0337426 A1
(43) Pub. Date: Oct. 29, 2026

(54) ADDITIVE MANUFACTURING OF COVALENT ORGANIC FRAMEWORK DEVICES VIA AEROSOL JET PRINTING OF COLLOIDALLY STABLE INKS AND APPLICATIONS OF SAME

(71) Applicant: NORTHWESTERN UNIVERSITY, Evanston, IL (US)

(72) Inventors: Mark C. Hersam, Wilmette, IL (US); William Robert Dichtel, Evanston, IL (US); Zoheb Hirani, Evanston, IL (US); Nathan Patrick Bradshaw, Evanston, IL (US); Lidia Kuo, Evanston, IL (US); Austin M. Evans, Evanston, IL (US); Nicholas Xavier Williams, Evanston, IL (US)

(21) Appl. No.: 19/485,322

(22) PCT Filed: May 16, 2024
(86) PCT No.: PCT/US2024/029571

§ 371 Date: Nov. 18, 2025

Related U.S. Application Data
(60) Provisional application No. 63/467,650, filed on May 19, 2023.

(51) Int. Cl. C09D 11/033; B33Y 10/00; B33Y 70/00; B33Y 80/00; C09D 11/102; C09D 11/52; G01K 7/16

(52) U.S. Cl. CPC C09D 11/033; C09D 11/102; C09D 11/52; G01K 7/16; B33Y 10/00; B33Y 70/00; B33Y 80/00; G01K 2211/00

(57) ABSTRACT

This invention discloses a solution-processable colloidal ink that enables aerosol jet printing of covalent organic framework (COF) films with micron-scale resolution. The colloidal ink consists of one or more solvents in addition to colloidal COFs dispersed in the one or more solvents. The ink formulation is also compatible with other colloidal nanomaterials, thus facilitating the integration of COFs into printable nanocomposite films. The invention establishes a flexible platform for COF additive manufacturing that can accelerate the incorporation of COFs into technologically significant applications.

### CROSS-REFERENCE TO RELATED PATENT APPLICATION

This application claims priority to and the benefit of U.S. Provisional Application No. 63/467,650, filed May 19, 2023, which is incorporated herein in its entirety by reference.

### STATEMENT AS TO RIGHTS UNDER FEDERALLY-SPONSORED RESEARCH

This invention was made with government support under grant number W911NF-15-1-0447 awarded by the Army Research Office, and grant number 70NANB19H05 awarded by the National Institute of Standards and Technology, and grant number DE-SC0019356-0004 awarded by the Department of Energy, and grant number DMR-1720139 awarded by the National Science Foundation. The government has certain rights in the invention.

### FIELD OF THE INVENTION

The present invention generally relates to material science, particularly to additive manufacturing of covalent organic framework devices via aerosol jet printing of colloidally stable inks and applications of the same.

### BACKGROUND OF THE INVENTION

The background description provided herein is to present the context of the invention generally. The subject matter discussed in the background of the invention section should not be assumed to be prior art merely due to its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

Covalent organic frameworks (COFs) are two-dimensional (2D) crystalline polymer networks with molecularly well-defined porous structures and tunable chemical versatility that hold significant potential for chemical sensing, storage, separations, and catalysis. In contrast to graphene or inorganic 2D materials, COFs are comprised of modular organic building blocks linked by covalent bonds. Recent reports of high thermal conductivities, exceptional thermal stability, and tunable redox properties have further broadened the range of potential applications for COFs. Despite this vast promise, COFs are typically synthesized as insoluble powders, which restricts their incorporation into functional materials and devices. To overcome these limitations, complex processing techniques are required such as solvothermal, interfacial, electrophoretic, and continuous-flow synthetic methods. Since these processing methods have limited substrate compatibility, introduce restrictive device design constraints, and/or lack precise geometrical control, recent efforts have attempted to employ additive manufacturing strategies to print COF precursors, which are then subsequently polymerized into patterned COF films. However, this approach requires long processing times, introduces cumbersome post-printing polymerization processing steps, and/or limits the range of compatible COF structures. Therefore, it is of high interest to develop alternative printing methodologies that are compatible with arbitrary COF structures and circumvent the need for arduous post-deposition processing.

Colloidal COF suspensions have multiple advantages relative to methods that rely on patterning and subsequent polymerization of COF monomers. Solution-phase COF polymerizations yield colloids that can be isolated, washed, and resuspended into stable solvent formulations that are amenable to film casting and printing. Furthermore, colloidal COF inks are compatible with additional low-dimensional materials that might otherwise interfere with COF polymerization, facilitating the formulation of nanocomposite functional inks. Stable colloidal dispersions have been previously reported for imine-linked, aqueous-stable COF nanoparticles by using surfactant mixtures as colloidal stabilizers. While these aqueous colloidal dispersions have been employed in a customized printing-mixing head for handheld ink writing, this method requires specialized equipment, involves co-depositing surfactants, and results in large printed features above 500 μm in lateral size. In another example, 3D printing of exfoliated imine-linked COF colloids has been achieved via suspension in a poly(2-hydroxyethyl methacrylate) matrix. However, this technique requires post-deposition curing and washing over multiple days, similar to methods used to deposit patterned COF precursors (panel A of FIG. 1). Previously, we established spray coating methods to incorporate colloidal boronate-ester COFs into large-area film devices for chemical sensing applications. Although spray coating takes advantage of pre-synthesized COF colloids, patterning in this case requires custom-designed shadow masks that are less amenable to rapid prototyping and high spatial resolution than direct-write printing methods.

Consequently, a need remains for the development of colloidal COF inks that allow for programmable deposition at micron-scale spatial resolution, which is particularly important for printed electronic and sensing applications.

### SUMMARY OF THE INVENTION

In view of the aforementioned deficiencies and inadequacies, this invention discloses a solution-processable colloidal ink that enables aerosol jet printing of COF films with micron-scale resolution. A key component of the ink formulation is the low-volatility solvent benzonitrile, which results in homogeneous printed COF film morphologies. This ink formulation is also compatible with other colloidal nanomaterials, thus facilitating the integration of COFs into printable nanocomposite films. As a proof-of-concept, boronate-ester COFs are integrated with carbon nanotubes (CNTs) to form printable COF-CNT nanocomposite films, in which the CNTs enhance charge transport. The resulting printed COF-CNT nanocomposite films enable high-sensitivity temperature sensors that significantly exceed the performance of previously reported CNT-polymer or COF-based temperature sensors. Accordingly, the invention establishes a flexible platform for COF additive manufacturing that can accelerate the incorporation of COFs into technologically significant applications.

Specifically, in one aspect of the invention, the colloidally stable ink comprises one or more solvents; and colloidal covalent organic frameworks (COFs) dispersed in the one or more solvents.

In one embodiment, the COFs are boronate-ester COFs.

In one embodiment, the boronate-ester COFs comprise COF-5 or COF-10. These COFs include hexahydroxytriphenylene paired with either 1,4-phenylenebisboronic acid (COF-5) or 4,4′-biphenyldiboronic acid (COF-10). Other colloidally stable boronate-ester COFs include those with pyrene-2,7-bisboronic acid (TP-COF), 4,4′-diphenylbutadiynebis(boronic acid) (DPB-COF), and 2,1,3-benzothiadiazole-4,7-bisboronic acid (TZD-COF).

In one embodiment, the COFs are imine-based colloidal COFs.

In one embodiment, the imine-based colloidal COFs comprise 1,3,5-tris(4-aminophenyl)benzene (TAPB), 4,4′,4″,4″-(ethene-1,1,2,2)-tetrayl)tetraaniline (ETTA), or 1,3,6,8-tetrakis(4-aminophenyl)pyrene (Py) nodes combined with a polyaldehyde linker.

In one embodiment, the imine-based colloidal COFs comprise TAPB-PDA-COF, TAPB-TFP-COF, and/or Py-COF.

In one embodiment, the one or more solvents are compatible with the COFs.

In one embodiment, the one or more solvents comprise acetonitrile (CH₃CN), dibutyl phthalate, ethyl lactate, and/or toluene.

In one embodiment, the one or more solvents further comprise at least one low volatility co-solvent that is chemically compatible with the COFs and maintains colloidal stability of the COFs.

In one embodiment, the at least one low volatility co-solvent comprises benzonitrile (PhCN), dibutyl phthalate, ethyl lactate, and/or toluene.

In one embodiment, a v:v ratio of CH₃CN:PhCN is printed at ratios of about 9:1, 8:2, 7:3, and 6:4.

In one embodiment, the ratio has an optimal ratio of about 7:3.

In one embodiment, the ink further comprises one or more nanomaterials dispersed with colloidal COFs.

In one embodiment, the one or more nanomaterials comprise at least one of: CNTs; two-dimensional (2D) nanomaterials including graphene oxide, hexagonal boron nitride, and/or transition metal dichalcogenides; one-dimensional (1D) nanomaterials including macrocycles and assembled nanotubes, and/or graphene ribbons; and zero-dimensional (0D) nanomaterials including quantum dots.

In one embodiment, the ink of claim 11, wherein a concentration of the CNTs in the ink is in a range of about 0.1-10 wt %.

In one embodiment, the CNTs act as conductive bridges between COF crystallites, facilitating charge transport through the COF matrix.

In one embodiment, the ink is compatible with aerosol jet printing (AJP).

In another aspect, the invention relates to a device comprising at least one element formed of the above disclosed ink on a substrate.

In one embodiment, the device has high thermal stabilities and in-plane thermal conductivities.

In one embodiment, the device has electrical conductivity and temperature sensitivity that are tunable.

In one embodiment, when operating just below the CNT percolation threshold, the device has about 4 orders of magnitude increase in the electrical conductivity over a temperature range from about 25° C. to about 300° C.

In one embodiment, the electrical conductivity depends on a CNT loading.

In one embodiment, an optimal value of the CNT loading in at least one element for temperature sensing is about 0.36 wt %.

In one embodiment, the electrical conductivity further depends on the degree of CNT percolation.

In one embodiment, the device is an all-printed temperature sensor.

In one embodiment, the all-printed temperature sensor comprises a COF-CNT nanocomposite film.

In one embodiment, the all-printed temperature sensor is fabricated by AJP of the COF-CNT nanocomposite film on the substrate.

In one embodiment, the COF-CNT nanocomposite film has a thickness in a chosen range of about 1-6 μm.

In one embodiment, the device has a linear ohmic charge transport for temperatures above 50° C.

In one embodiment, the COF-CNT nanocomposite film is a COF-5-CNT nanocomposite film or a COF-10-CNT nanocomposite film, wherein, at the same CNT loading, the COF-5-CNT nanocomposite film has a temperature sensitivity higher than that of the COF-10-CNT nanocomposite film.

In one embodiment, the all-printed temperature sensor has high local temperature coefficient of resistances (TCRs), which decrease in magnitude at higher temperatures as expected for exponential temperature dependence.

In one embodiment, the all-printed COF-10-CNT and COF-5-CNT temperature sensors yield temperature resistance ratio (TRR) values of about 24.5% ° C.⁻¹ and about 1702% ° C.⁻¹, respectively, which are about 3-180 times larger than the highest values for a CNT-polymer temperature sensor.

In one embodiment, the all-printed temperature sensor has exponential changes in the electrical conductivity over a wide temperature range.

In one embodiment, across the temperature range of about 25° C. to about 300° C., the COF-5-CNT temperature sensor has a conductivity ratio (σ_{300° C.}/σ_{25° C.}) of about 10⁴, which is corresponding to a percentage change in conductivity per degree of about 1940% ° C.⁻¹.

In one embodiment, the all-printed COF-CNT nanocomposite device has higher temperature sensitivities and wider temperature ranges than that of a CNT-polymer temperature sensor or a COF-based temperature sensor.

In one embodiment, the all-printed COF-CNT temperature sensors have reversible conductivities upon temperature cycling between room temperature and about 300° C.

In one embodiment, the printed COF-5-CNT device is configured such that an instantaneous and repeatable drop in conductivity occurs immediately upon removal from a heat source at about 300° C., followed by a linear return to the room-temperature baseline conductivity within a few minutes, and wherein upon returning the sensor to the heated surface at about 300° C., the high-temperature conductivity is restored within seconds.

In one embodiment, the device is operable in high-temperature environments.

In one embodiment, the device is bendable.

In one embodiment, the device is wearable.

In one aspect, the invention relates to a method of forming a colloidally stable ink. The method comprises combining monomers in a mixture of acetonitrile, 1,4-dioxane, and mesitylene to form a monomer solution; filtering and heating the monomer solution to result in COFs; isolating and washing the resulted COFs by centrifugation to yield sedimented pellets of the COFs; and resuspending the COFs in CH₃CN to yield a stable COF colloidal ink.

In one embodiment, the mixture has a v/v ratio of acetonitrile:1,4-dioxane:mesitylene being about 16:4:1 (vol %).

In one embodiment, said combining the monomers in the mixture comprises dissolving and sonicating the monomers together in the mixture.

In one embodiment, said filtering and heating the monomer solution is performed without stirring at about 85° C. overnight.

In one embodiment, the monomers comprise 2,3,6,7,10,11-hexahydroxytriphenylene (HHTP), and a boronic acid including 1,4-phenylenediboronic acid (PBBA), 4,4′-biphenylenediboronic acid (BPBBA), pyrene-2,7-bisboronic acid (TP), 4,4-diphenylbutadiynebis(boronic acid) (DPB), and/or 2,1,3-benzothiadiazole-4,7-bisboronic acid (TZD).

In one embodiment, the method further comprises optimizing the COF colloidal ink for favorable printing conditions.

In one embodiment, said optimizing the COF colloidal ink comprises adding one or more lower volatility co-solvents that chemically compatible with boronate-ester COFs and maintain COF colloidal stability, for controlling an evaporation rate during ink atomization.

In one embodiment, the one or more lower volatility co-solvents comprise PhCN.

In one embodiment, a v/v ratio of CH₃CN:PhCN is assessed at ratios of about 9:1, 8:2, 7:3, and 6:4.

In one embodiment, the ratio has an optimal ratio of about 7:3.

In one embodiment, the method further comprises dispersing one or more nanomaterials in the COF colloidal ink.

In one embodiment, the one or more nanomaterials comprise CNTs; 2D nanomaterials including graphene oxide, hexagonal boron nitride, and/or transition metal dichalcogenides; 1D nanomaterials including macrocycles and assembled nanotubes, and/or graphene ribbons; and 0D nanomaterials including quantum dots.

In one embodiment, a concentration of the CNTs in the COF colloidal ink is in a range of about 0.1-10 wt %.

In one embodiment, the ink is compatible with AJP.

In another aspect, the invention relates to a method for additive manufacturing of a COF device. The method comprises providing a COF colloidal ink; and adding one or more nanomaterials in the COF colloidal ink to form a COF nanomaterial colloidal ink; and aerosol jet printing of the COF-nanomaterial colloidal ink on a substrate to form a COF-nanomaterial device.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows (panel A) schematic of prior efforts to inkjet print COF precursors followed by polymerization to form crystalline COF patterns, (panel B) schematic of the approach in this work where colloidal COFs are directly patterned via aerosol jet printing, and (panel C) molecular structures of the unit cells of the 2D boronate-ester COFs (COF-5 and COF-10) used in this invention.

FIG. 2 shows (panel A) average thickness of COF-5 prints as a function of CH₃CN:PhCN ratio for varying printing passes, where the prints were deposited at 40 sccm flow rate and 2 mm/s printing speed, (panel B) (top) schematic showing rougher films resulting from uncontrollably fast solvent evaporation with CH₃CN alone and (bottom) schematic depicting more homogenous films resulting from controlled slower solvent evaporation upon the addition of PhCN to the ink formulation, and (panels C and D) cross-sectional scanning electron microscopy images of printed COF-5 films from ink composed of (panel C) 9:1 CH₃CN:PhCN and (panel D) 7:3 CH₃CN:PhCN co-solvent mixtures.

FIG. 3 shows (panel A) printed lines of COF-5 on silicon substrates (0.5 mm/s, 1 pass) and (panel B) corresponding profilometry of vertical heights (i.e., thicknesses) of the printed lines, (panel C) printed lines of COF-10 on silicon substrates (0.5 mm/s, 1 pass) and (panel D) corresponding profilometry of vertical heights (i.e., thicknesses) of the printed lines, and (panel E) grazing-incidence X-ray diffraction intensity linecut for printed COF films along q_{z}=0. Colloidal ink in solvo capillary X-ray diffraction and simulated Pawley refinement patterns are also included.

FIG. 4 shows (panel A) measured current versus temperature for dropcasted COF-5 films on graphene interdigitated electrodes on polyimide substrates for different CNT loadings. COF-5 films containing 0 wt % CNT, 0.12 wt % CNT, and 0.36 wt % CNT were measured at an applied bias of 40 V due to their low electrical conductivities. In contrast, the films containing 2.66 wt % and 9 wt % CNT were measured at 1 V, and films of 100 wt % CNT were measured at 0.1 V, and (panel B) schematic describing CNT percolation effects on the conductivity of COF-CNT nanocomposite films.

FIG. 5 shows (panel A) current-voltage plots as a function of temperature for printed COF-5-CNT nanocomposite devices at 0.36 wt % CNT loading. The device was printed at 40 sccm flow rate, 1 mm/s printing speed, and 5 printing passes (photograph provided in the inset), (panel B) extracted electrical conductivity as a function of temperature from the current-voltage plots in panel A, (panel C) reversible temperature-dependent electrical conductivity is observed following temperature cycling between room temperature and 300° C., and (panel D) electrical conductivity is essentially invariant as a function of bending cycles (bending radius of 12 mm), showing the mechanical flexibility and resilience of the all-printed COF-CNT nanocomposite devices.

FIG. 6 shows a general scheme for synthesis of colloidal COF inks. Carbon nanotubes were mixed into the ink to print composite devices.

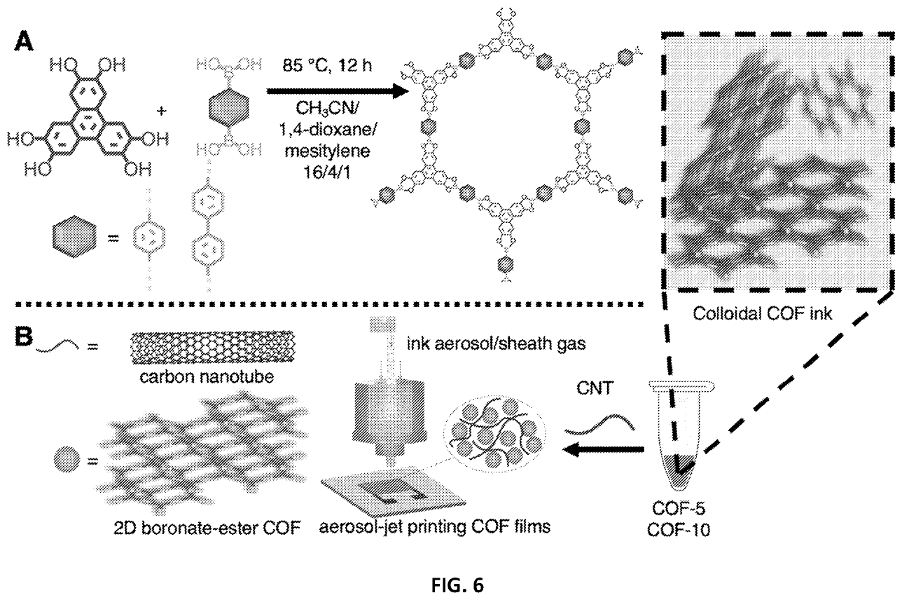

FIG. 7 shows a general scheme for synthesis of colloidal COF inks for carbon nanotube integration and aerosol jet printing.

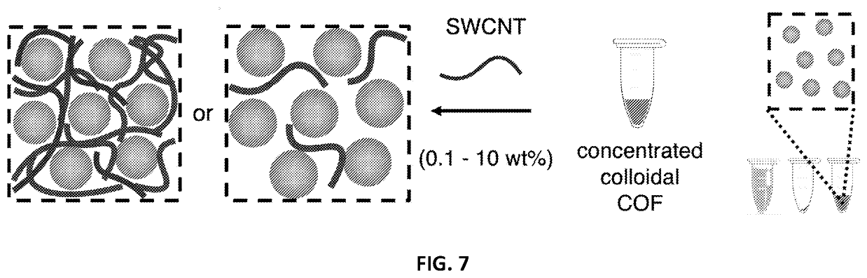

FIG. 8 shows a capillary XRD pattern of the colloidal COF-5 ink containing 7:3 acetonitrile:benzonitrile prior to printing. Predicted XRD pattern for COF-5 without Pawley refined fitting is shown.

FIG. 9 shows a capillary XRD pattern of colloidal COF-10 ink containing 7:3 acetonitrile:benzonitrile prior to printing. Predicted XRD pattern for COF-10 without Pawley refined fitting is shown.

FIG. 10 shows optical absorbance spectra of HHTP (2,3,6,7,10,11-hexahydroxytriphenylene), PBBA (1,4-phenylenediboronic acid), COF-5 colloidal suspension, and processed COF-5 ink.

FIG. 11 shows grazing incidence wide-angle X-ray scattering (GIWAXS) pattern of printed COF-10 on a silicon substrate.

FIG. 12 shows grazing-incidence X-ray diffraction (GIXRD) pattern of (panel A) dropcasted COF-5-CNT ink and (panel B) aerosol-jet-printed COF-5-CNT ink. Both substrates are silicon containing graphene and gold interdigitated electrodes. Signals arising from gold are marked with an asterisk (*).

FIG. 13 shows grazing-incidence X-ray diffraction (GIXRD) line cuts of printed COF-5-CNT (red) compared to line cuts of dropcasted COF-5-CNT ink (green). In operando line cuts taken on a Linkam stage set at 150° C. and 10 V for one hour is shown for comparison (orange). All line cuts are taken along q_{z}=0 and phi=160-180°.

FIG. 14 shows FTIR spectra of printed COF-5 and COF-10 on polyimide substrates.

FIG. 15 shows Boronate-ester vibrational modes indicated on the FTIR spectra of printed COF-5 and COF-10 on polyimide substrates.

FIG. 16 shows (panel A) optical image and (panel B) corresponding scanning electron micrograph of AJP square of COF-5 on a silicon substrate.

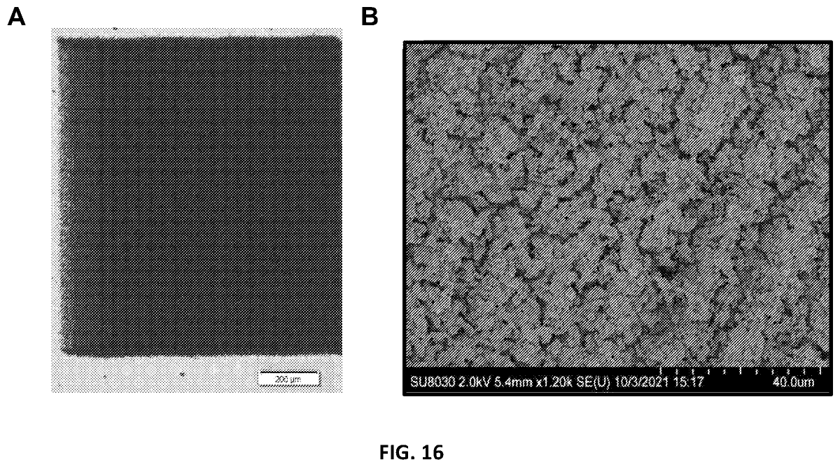

FIG. 17 shows cross-sectional scanning-electron micrographs of lines printed with 3 layers of COF-10 from inks containing (panels A and C) 10% PhCN/CH₃CN and (panels B and D) 30% PhCN/CH₃CN.

FIG. 18 shows SEM images of dropcasted COF-5 containing 0.36 wt % CNT.

FIG. 19 shows profilometry of COF-10-CNT devices printed on polyimide. The device thickness is 2.6 (±0.3) μm.

FIG. 20 shows profilometry of COF-5-CNT devices printed on polyimide. The device thickness is 3.8 (±0.9) μm.

FIG. 21 shows (panel A) conductivity as a function of temperature, measured at a bias of 40 V for both the COF-5-CNT and COF-10-CNT samples with 0.36 wt % CNTs, and (panel B) corresponding ratio of conductivity change compared to Go, the reference conductivity at 25° C. (σ_{T}/σ₀, where or is the conductivity at temperature T). We note these values are the same as R₀/R_{T}, where R is resistance.

FIG. 22 shows COF-5-CNT sensor resistance at varying temperature recorded at 25° C. intervals. The data is plotted using (panel A) exponential fitting to yield R_{COF-5-CNT}=−3.55E13Ω+(2.42E12Ω)*e^{-T/22.64}+(3.5503E13Ω)*e^{-T/4857000}, R²=0.95, and (panel B) Local TCRs per 1° C. change at each temperature as determined by the exponential fit.

FIG. 23 shows COF-10-CNT sensor resistance at varying temperature recorded at 25° C. intervals. The data is plotted using (panel A) exponential fitting to yield R_{COF-10-CNT}=1.1777E7Ω+(2.7390E11Ω)*e^{-T/3.418}+(1.5505E9Ω)*e^{-T/50.558}, R²=0.99, and (panel B) Local TCRs per 1° C. change at each temperature as determined by the exponential fit.

### DETAILED DESCRIPTION OF THE INVENTION

The invention will now be described more fully hereinafter with reference to the accompanying drawings, in which exemplary embodiments of the invention are shown. However, this invention may be embodied in many different forms and should not be construed as limited to the embodiments set forth herein. Rather, these embodiments are provided so that this specification will be thorough and complete and fully convey the invention's scope to those skilled in the art. Like reference numerals refer to like elements throughout.

The terms used in this specification generally have their ordinary meanings in the art, within the context of the invention, and in the specific context where each term is used. Certain terms used to describe the invention are discussed below, or elsewhere in the specification, to provide additional guidance to the practitioner regarding the description. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, or section without departing from the invention's teachings.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures. is turned over, elements described as being on the “lower” side of other elements would then be oriented on “upper” sides of the other elements. The exemplary term “lower”, can, therefore, encompasses both an orientation of “lower” and “upper,” depending on the particular orientation of the figure. Similarly, if the device in one of the figures is turned over, elements described as “below” or “beneath” other elements would then be oriented “above” the other elements. Therefore, the exemplary terms “below” or “beneath” can encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this specification, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

As used in this specification, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this specification, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in a different order (or concurrently) without altering the principles of the invention.

In recent years, significant progress has been made in uncovering the material properties of covalent organic frameworks (COFs), including high thermal stabilities, tunable redox properties, and high thermal conductivities. These properties make COFs a promising platform for numerous commercial fields such as sensors for health and human safety, environmental monitoring, agriculture, etc. However, COFs are typically synthesized as insoluble powders, which complicates their incorporation into thin-film devices, particularly via additive manufacturing. Due to these processing limitations, exploration of these materials has largely been limited to academic studies.

To overcome these limitations, complex processing techniques are required such as solvothermal, interfacial, electrophoretic, and continuous-flow synthetic methods. However, these processing methods are not yet scalable, have limited substrate compatibility, and lack precise geometrical control. Efforts to employ additive manufacturing strategies involve printing of COF precursors that are then subsequently polymerized. This technique introduces cumbersome post-printing polymerization processing steps and limits the range of compatible COF structures. In summary, the current limitations of this technology that limit commercialization are as follows:
COF precursor processing requires extended processing times of upwards of 2+ days, increasing manufacturing costs. Prior reports of printing COFs involve post-deposition processing over days, which can include washing, heating, and drying to very low pressures or involve super-critical CO₂ and/or freeze-drying. These confer large capital equipment costs, significant energy, and chemical burdens associated with printing.
Manufacturing COF thin films necessitates inordinate capital expenditure that is not amenable to scalable manufacturing offered by solution-processable polymers. Current techniques that aim to reduce processing costs are only compatible with a limited subset of COFs, reducing their utility and broad commercial appeal.
No technology for scalable COF device printing has been commercially demonstrated that can provide lateral and vertical resolutions below 100 μm without specialized, non-commercial printers.

One of the objectives of the invention is to provide pre-synthesized, solution-processable colloidal COF inks that enable aerosol jet printing of COFs with micron-scale spatial resolution. A key component of the ink formulation is the low-volatility solvent benzonitrile, which is critical to obtaining homogeneous printed COF film morphologies. This same ink formulation can simultaneously include other nanomaterials, e.g., carbon nanotubes (CNTs), which enables additive manufacturing of COF nanocomposite films. For example, printed COF-CNT nanocomposite films show high in-plane COF crystallinity and retain their chemical composition throughout the printing process. Lateral scale resolution below 50 μm is obtained by controlling the sheath gas flow rate, printing speed, and other parameters. Scalable printing with geometric control is critical for printable devices. As a proof-of-concept, we demonstrate high-sensitivity temperature sensors with electrical conductivity variation by 4 orders of magnitude between room temperature and 300° C. Overall, this invention establishes a flexible platform for COF additive manufacturing that can accelerate the incorporation of COFs into technologically significant applications.

Without intent to limit the scope of the invention, exemplary embodiments of the invention are given below.

In one aspect of the invention, the colloidally stable ink comprises one or more solvents; and colloidal COFs dispersed in the one or more solvents.

In one embodiment, the COFs are boronate-ester COFs.

In one embodiment, the boronate-ester COFs comprise COF-5 or COF-10. These COFs include hexahydroxytriphenylene paired with either 1,4-phenylenebisboronic acid (COF-5) or 4,4′-biphenyldiboronic acid (COF-10). Other colloidally stable boronate-ester COFs include those with pyrene-2,7-bisboronic acid (TP-COF), 4,4′-diphenylbutadiynebis(boronic acid) (DPB-COF), and 2,1,3-benzothiadiazole-4,7-bisboronic acid (TZD-COF).

In one embodiment, the COFs are imine-based colloidal COFs. These include COFs consisting of 1,3,5-tris(4-aminophenyl)benzene (TAPB), 4,4′,4″,4″-(ethene-1,1,2,2)-tetrayl) tetraaniline (ETTA), or 1,3,6,8-tetrakis(4-aminophenyl)pyrene (Py) nodes combined with a polyaldehyde linker. Some COFs include TAPB-PDA-COF, TAPB-TFP-COF, and Py-COF.

In one embodiment, the COFs are imine-based colloidal COFs.

In one embodiment, the imine-based colloidal COFs comprise 1,3,5-tris(4-aminophenyl)benzene (TAPB), 4,4′,4″,4′-(ethene-1,1,2,2)-tetrayl)tetraaniline (ETTA), or 1,3,6,8-tetrakis(4-aminophenyl)pyrene (Py) nodes combined with a polyaldehyde linker.

In one embodiment, the imine-based colloidal COFs comprise TAPB-PDA-COF, TAPB-TFP-COF, and/or Py-COF.

In one embodiment, the one or more solvents are compatible with the COFs.

In one embodiment, the one or more solvents comprise acetonitrile (CH₃CN), dibutyl phthalate, ethyl lactate, and/or toluene.

In one embodiment, the one or more solvents further comprise at least one low volatility co-solvent that is chemically compatible with the COFs and maintains colloidal stability of the COFs.

In one embodiment, the at least one low volatility co-solvent comprises benzonitrile (PhCN), dibutyl phthalate, ethyl lactate, and/or toluene.

In one embodiment, a v:v ratio of CH₃CN:PhCN is printed at ratios of about 9:1, 8:2, 7:3, and 6:4.

In one embodiment, the ratio has an optimal ratio of about 7:3.

In one embodiment, the ink further comprises one or more nanomaterials dispersed with colloidal COFs.

In one embodiment, the one or more nanomaterials comprise at least one of: CNTs; two-dimensional (2D) nanomaterials including graphene oxide, hexagonal boron nitride, and/or transition metal dichalcogenides; one-dimensional (1D) nanomaterials including macrocycles and assembled nanotubes, and/or graphene ribbons; and zero-dimensional (0D) nanomaterials including quantum dots.

In one embodiment, the ink of claim 11, wherein a concentration of the CNTs in the ink is in a range of about 0.1-10 wt %.

In one embodiment, the CNTs act as conductive bridges between COF crystallites, facilitating charge transport through the COF matrix.

In one embodiment, the ink is compatible with aerosol jet printing (AJP).

In another aspect, the invention relates to a device comprising at least one element formed of the above disclosed ink on a substrate.

In one embodiment, the device has high thermal stabilities and in-plane thermal conductivities.

In one embodiment, the device has electrical conductivity and temperature sensitivity that are tunable.

In one embodiment, when operating just below the CNT percolation threshold, the device has about 4 orders of magnitude increase in the electrical conductivity over a temperature range from about 25° C. to about 300° C.

In one embodiment, the electrical conductivity depends on a CNT loading.

In one embodiment, an optimal value of the CNT loading in at least one element for temperature sensing is about 0.36 wt %.

In one embodiment, the electrical conductivity further depends on the degree of CNT percolation.

In one embodiment, the device is an all-printed temperature sensor.

In one embodiment, the all-printed temperature sensor comprises a COF-CNT nanocomposite film.

In one embodiment, the all-printed temperature sensor is fabricated by AJP of the COF-CNT nanocomposite film on the substrate.

In one embodiment, the COF-CNT nanocomposite film has a thickness in a chosen range of about 1-6 μm.

In one embodiment, the device has a linear ohmic charge transport for temperatures above 50° C.

In one embodiment, the COF-CNT nanocomposite film is a COF-5-CNT nanocomposite film or a COF-10-CNT nanocomposite film, wherein, at the same CNT loading, the COF-5-CNT nanocomposite film has a temperature sensitivity higher than that of the COF-10-CNT nanocomposite film.

In one embodiment, the all-printed temperature sensor has high local temperature coefficient of resistances (TCRs), which decrease in magnitude at higher temperatures as expected for exponential temperature dependence.

In one embodiment, the all-printed COF-10-CNT and COF-5-CNT temperature sensors yield temperature resistance ratio (TRR) values of about 24.5% ° C.⁻¹ and about 1702% ° C.⁻¹, respectively, which are about 3-180 times larger than the highest values for a CNT-polymer temperature sensor.

In one embodiment, the all-printed temperature sensor has exponential changes in the electrical conductivity over a wide temperature range.

In one embodiment, across the temperature range of about 25° C. to about 300° C., the COF-5-CNT temperature sensor has a conductivity ratio (σ_{300° C.}/σ_{25° C.}) of about 10⁴, which is corresponding to a percentage change in conductivity per degree of about 1940% ° C.⁻¹.

In one embodiment, the all-printed COF-CNT nanocomposite device has higher temperature sensitivities and wider temperature ranges than that of a CNT-polymer temperature sensor or a COF-based temperature sensor.

In one embodiment, the all-printed COF-CNT temperature sensors have reversible conductivities upon temperature cycling between room temperature and about 300° C.

In one embodiment, the printed COF-5-CNT device is configured such that an instantaneous and repeatable drop in conductivity occurs immediately upon removal from a heat source at about 300° C., followed by a linear return to the room-temperature baseline conductivity within a few minutes, and wherein upon returning the sensor to the heated surface at about 300° C., the high-temperature conductivity is restored within seconds.

In one embodiment, the device is operable in high-temperature environments.

In one embodiment, the device is bendable.

In one embodiment, the device is wearable.

In one aspect, the invention relates to a method of forming a colloidally stable ink. The method comprises combining monomers in a mixture of acetonitrile, 1,4-dioxane, and mesitylene to form a monomer solution; filtering and heating the monomer solution to result in COFs; isolating and washing the resulted COFs by centrifugation to yield sedimented pellets of the COFs; and resuspending the COFs in CH₃CN to yield a stable COF colloidal ink.

In one embodiment, the mixture has a v/v ratio of acetonitrile:1,4-dioxane:mesitylene being about 16:4:1 (vol %).

In one embodiment, said combining the monomers in the mixture comprises dissolving and sonicating the monomers together in the mixture.

In one embodiment, said filtering and heating the monomer solution is performed without stirring at about 85° C. overnight.

In one embodiment, the monomers comprise 2,3,6,7,10,11-hexahydroxytriphenylene (HHTP), and a boronic acid including 1,4-phenylenediboronic acid (PBBA), 4,4′-biphenylenediboronic acid (BPBBA), pyrene-2,7-bisboronic acid (TP), 4,4-diphenylbutadiynebis(boronic acid) (DPB), and/or 2,1,3-benzothiadiazole-4,7-bisboronic acid (TZD).

In one embodiment, the method further comprises optimizing the COF colloidal ink for favorable printing conditions.

In one embodiment, said optimizing the COF colloidal ink comprises adding one or more lower volatility co-solvents that chemically compatible with boronate-ester COFs and maintain COF colloidal stability, for controlling an evaporation rate during ink atomization.

In one embodiment, the one or more lower volatility co-solvents comprise PhCN.

In one embodiment, a v/v ratio of CH₃CN:PhCN is assessed at ratios of about 9:1, 8:2, 7:3, and 6:4.

In one embodiment, the ratio has an optimal ratio of about 7:3.

In one embodiment, the method further comprises dispersing one or more nanomaterials in the COF colloidal ink.

In one embodiment, the one or more nanomaterials comprise CNTs; 2D nanomaterials including graphene oxide, hexagonal boron nitride, and/or transition metal dichalcogenides; 1D nanomaterials including macrocycles and assembled nanotubes, and/or graphene ribbons; and 0D nanomaterials including quantum dots.

In one embodiment, a concentration of the CNTs in the COF colloidal ink is in a range of about 0.1-10 wt %.

In one embodiment, the ink is compatible with AJP.

In another aspect, the invention relates to a method for additive manufacturing of a COF device. The method comprises providing a COF colloidal ink; and adding one or more nanomaterials in the COF colloidal ink to form a COF nanomaterial colloidal ink; and aerosol jet printing of the COF-nanomaterial colloidal ink on a substrate to form a COF-nanomaterial device.

In one embodiment, the one or more nanomaterials comprise carbon nanotubes.

Among other things, the invention has at least the following advantages over the prior art.

Ink Formulation: Significant progress has been made in uncovering device-relevant properties of COFs, including high thermal stabilities, tunable redox properties, and relatively high thermal conductivity. However, COFs are typically synthesized as insoluble powders, which restricts their incorporation into functional materials and devices. To overcome these limitations, complex processing techniques are required such as solvothermal, interfacial, electrophoretic, and continuous-flow synthetic methods. However, these processing methods are not yet scalable, have limited substrate compatibility, and lack precise geometrical control. This invention uses colloidal boronate-ester COF suspensions that have multiple advantages relative to methods that rely on patterning and subsequent polymerization of COF monomers. In particular, specialized solution-phase COF polymerizations containing nitrile co-solvents yield colloids that can be isolated, washed, and resuspended into stable solvent formulations that are amenable to film casting and printing. Other solution-phase COF polymerizations do not produce stable colloidal inks. In one aspect, the invention provides an ink formulation that enables aerosol jet printing of colloidal boronate-ester COFs, formulated in acetonitrile and benzonitrile. The addition of benzonitrile is key to enabling atomization of ink and to achieving a favorable, uniform morphology and high-resolution features. This ink formulation allows for the addition of other nanomaterials to the ink, allowing simultaneous deposition that results in printable nanocomposite films. In some embodiments, boronate-ester COFs are integrated with CNTs to form printable COF-CNT nanocomposite films, in which the CNTs enhance charge transport and sensitivity to changes in temperature.

Printing: Previously established colloidal dispersions have been successfully applied for printing imine-linked, aqueous-stable COF nanoparticles. However, this approach relies on aggregated particles, limiting morphological control. Furthermore, the printing requires customized printing mixing-heads, co-deposition of surfactants that may negatively interact with other COF families, narrow and limiting range of viscosities, and lines with poor spatial resolution above 500 μm in lateral size. Efforts to employ additive manufacturing strategies involve printing of COF precursors that are then subsequently polymerized. However, this approach requires long processing times, introduces cumbersome post-printing polymerization processing steps, and/or limits the range of compatible COF structures. In another example, 3D printing of exfoliated imine-linked COF colloids has been achieved via suspension in a poly(2-hydroxyethyl methacrylate) matrix. However, this technique requires post-deposition curing and washing over multiple days, similar to methods used to deposit patterned COF precursors. This invention, among other things, employs AJP, which exhibits micron-scale spatial resolution, tolerates a broad range of ink viscosities, and is less susceptible to nozzle clogging, which is especially critical for colloidal inks. Ultimately, 36 micron resolution is achieved, which is considerably finer than other previous COF printing efforts. Although supercritical drying is often required for COF powders and films, the optimized AJP inks and printing conditions according to the invention require no additional post-processing to attain crystalline COF films. The colloidal ink technique according to the invention establishes a versatile additive manufacturing platform for the scalable fabrication of COFs as thin films, thereby harnessing their unique properties for a diverse range of technologically significant applications.

Printed Temperature Sensors: Embodiments of the invention demonstrate the utility of AJP colloidal COF and CNT-COF inks for printed temperature sensors with screen-printed graphene interdigitated electrodes on flexible polyimide substrates. Because the addition of CNTs enhance charge transport, the resulting printed COF-CNT nanocomposite films enable high-sensitivity temperature sensors that significantly exceed the performance of previously reported CNT-polymer or COF-based temperature sensors. These printed COF-CNT sensors demonstrate reversible temperature sensing and are mechanically robust on flexible substrates, thus making them suitable for wearable electronics.

The invention can be applied to the fields of printed electronics, chemical sensing, conductive coatings, batteries, flexible electronics, structural composites, and the likes.

These and other aspects of the invention are further described below. Without intent to limit the scope of the invention, exemplary instruments, apparatus, methods, and their related results according to the embodiments of the invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### EXAMPLE

### Aerosol-Jet-Printable Covalent Organic Framework Colloidal Inks and Temperature-Sensitive Nanocomposite Films

With molecularly well-defined and tailorable two-dimensional structures, covalent organic frameworks (COFs) have emerged as leading material candidates for diverse applications including chemical sensing, storage, separation, and catalysis. To fully realize this technological potential, it is of high interest to directly and deterministically print COFs into arbitrary geometries. However, previous additive manufacturing attempts for COFs have been restricted by low spatial resolution and/or post-deposition polymerization that severely restrict downstream applications.

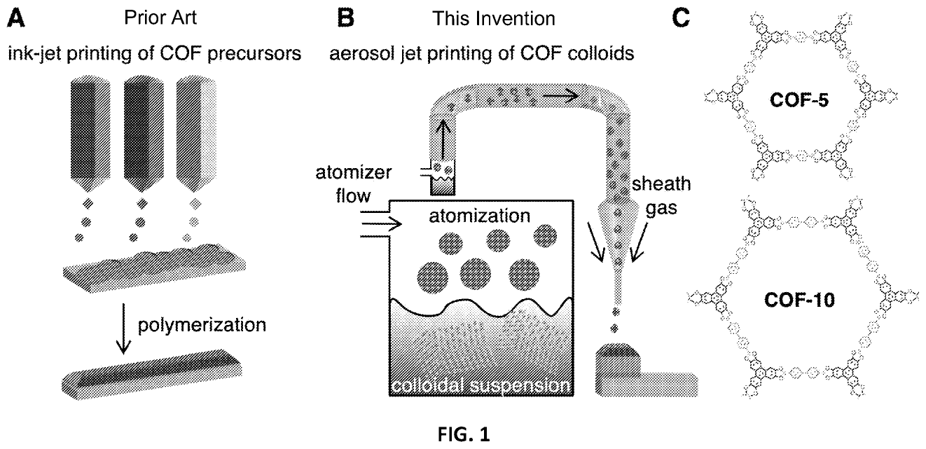

In this exemplary study, we report an ink formulation that enables aerosol jet printing (AJP) of colloidal COFs. AJP is a flexible additive manufacturing technique that has not previously been reported for colloidal COFs but has been used extensively for fabricating other nanomaterial devices. During AJP, ink droplets aerosolized by a megasonic atomizer are transported via an inert carrier gas to the printing nozzle where the droplet stream is collimated by an annular sheath gas, thus resulting in high-resolution deposition (panel B of FIG. 1). In addition to micron-scale spatial resolution, AJP offers additional advantages such as compatibility with diverse substrates and ink formulations. Moreover, compared to inkjet printing, AJP tolerates a broader range of ink viscosities and is less susceptible to nozzle clogging, which is especially critical for colloidal inks. Despite these advantages, the aerosolization process required for AJP can be detrimental to delicate materials, which necessitates careful design of ink formulations to ensure colloidal stability throughout the patterning process. Towards this end, we employ the low-volatility solvent benzonitrile in our colloidal COF inks, which preserve COF crystallinity throughout ink atomization, collimation, and printing, thereby retaining the designed COF structures in high-resolution patterns. Although supercritical drying is often required for COF powders and films, our optimized AJP inks and printing conditions require no additional post-processing to attain crystalline COF films.

Importantly, our colloidal COF ink formulations are compatible with other nanomaterials, thus enabling AJP of COF-based nanocomposite films. In particular, beyond demonstrating AJP of boronate-ester COFs (e.g., COF-5 and COF-10 as depicted in panel C of FIG. 1), we also formulate and print hybrid inks including COFs and carbon nanotubes (CNTs), where the CNTs act as a conductive additive to improve the electrical properties of the printed COF films. The resulting COF-CNT nanocomposite films show a strong temperature dependence of electrical conductivity, which enables all-printed temperature sensors with reversible, robust, and sensitive temperature responses including higher temperature coefficient of resistance values (TCR_{COF-5-CNT}=−2.6% ° C.⁻¹ and TCR_{COF-10-CNT}=−1.4% ° C.⁻¹) than previously demonstrated CNT-polymer temperature sensors. Since AJP enables printing on flexible substrates that otherwise degrade under conditions required for solution-phase COF polymerization, our COF-CNT nanocomposite temperature sensors are also mechanically flexible and resilient. Overall, this work establishes a versatile additive manufacturing platform that can harness the unique properties of 2D COFs for a diverse range of technologically significant applications.

### Materials and Methods

Materials. Reagents were purchased from commercial grade suppliers and used without further purification, unless otherwise described. Anhydrous solvents were obtained from a solvent purification system (JC Meyer System). All boronic acids and pinacol esters were either prepared as described or purchased commercially and used without further purification. Compounds used without further purification include 2,3,6,7,10,11-hexahydroxytriphenylene, 1,4-phenylenediboronic acid, and 4,4′-biphenylenediboronic acid. Single-walled carbon nanotubes were purchased from CHASM Advanced Materials (SG76). Anhydrous solvents were obtained from a solvent purification system (JC Meyer System). Solvent mixtures prior to COF preparation were stored under activated molecular sieves (4 Å) overnight.

Synthesis of Colloidal COF Inks. Colloidal inks of covalent organic frameworks were prepared by sonication and heating of monomers 2,3,6,7,10,11-hexahydroxytriphenylene (HHTP, 2 mmol, 52 mg) and either 1,4-phenylenediboronic acid (PBBA, 3 mmol, 40 mg) or 4,4′-biphenylenediboronic acid (BPBBA, 3 mmol, 58 mg). The monomers were dissolved and sonicated together in CH₃CN:1,4-dioxane:mesitylene (16:4:1 CH₃CN:1,4-dioxane:mesitylene, 50 mM HHTP). The monomer solution was filtered (using either a 0.45-micron PTFE syringe or P4 paper filter) and heated without stirring at 85° C. overnight. Within 20 min, the solution turns into a stable, translucent colloidal suspension with no COF aggregation. Final stable colloidal COF solutions (50 mM HHTP, 75 mM X-Boronic Acid) were further concentrated into final inks for printing. It should be noted that small amounts of oxidized HHTP can cause aggregation in the COF synthesis.

Additionally, we attempted to prepare ink formulations from traditionally synthesized and activated COF powders. Attempts to dissolve the powders in similar solvent contents with heating and sonication only resulted in poorly dispersed suspensions that could not be atomized for printing. As the same trends were observed for both COF-5 and COF-10, we concluded that colloidal processing was necessary for preparing printable ink formulations.

Aerosol Jet Printing of COF Inks. Prior to AJP, substrates were plasma cleaned for 2 min. COF-5 and COF-10 inks with varying CNT loadings were printed at a flow rate of 35-40 sccm and sheath gas flow rate of 50 sccm on an AJ200 printer (Optomec). The stage temperature was set to 60° C., the atomizer bath was set to 30° C., and the atomizer current was set to the maximum level (~0.5 mA). Printing speeds varied from 1-4 mm/s and the number of printing passes varied from 1-5 passes.

Screen Printing Graphene Interdigitated Electrodes. The interdigitated electrodes were screen printed using a conductive graphene ink. Ethyl cellulose-coated graphene nanoplatelets and terpineol were mixed in a centrifugal mixer (ARE-310, Thinky USA) at a concentration of 140 mg/mL. The resulting ink was printed on polyimide using an automatic screen printer (886PC DSIV, Hary Manufacturing Inc.) and a stainless steel 325-mesh screen. The prints were performed with a squeegee pressure of 20 psi, a speed of 127 mm/s, and a snapoff distance of ~1 mm. Finally, the graphene electrodes were cured in a box furnace for 30 min at 350° C.

Grazing-Incidence X-ray Diffraction. Grazing incidence wide-angle X-ray scattering (GIWAXS) measurements were performed at either:
(1) Advanced Photon Source at Argonne National Laboratory using Sector 8-IDE Beamline under vacuum. All measurements were conducted with an incidence angle of 0.14° using 10.92 keV (2=1.1354 Å) X-rays. The scattered photons were recorded on a Pilatus 1 M detector located 22.9 cm from the sample. Exposure times were varied such that the pixel with maximum counts was at 10-80% of saturation. The raw images were merged, pixel coordinates were transformed to q-space, and line cuts were generated using GIXSGUI for Matlab. Line cuts were integrated from phi angles of 160-180 degrees to extract in-plane XRD.
(2) National Synchrotron Light Source II (NSLS-II) at Brookhaven National Laboratory using Sector 11-BM Beamline under vacuum. All measurements were conducted at incident angles between 0.05-0.14° using 13.5 keV (2=0.9184 Å) X-rays. The scattered photons were recorded on a Pilatus 1 M detector located 25.9 cm from the sample. Exposure times were varied such that the pixel with maximum counts was at 80% of saturation. The raw images were merged, pixel coordinates were transformed to q-space, and line cuts were processed using GIXSGUI for Matlab. Line cuts were mainly integrated from phi angles of 160-180 degrees to extract in-plane XRD.

All XRD data is shown as a function of the scattering vector: Q=4πλ sin(θ).

COF Modeling and Structural Refinement. The simulated powder XRD of COF structures was determined using the Materials Studio (ver 5.0) suite of programs by Accelrys. The initial structures were constructed piecewise starting with a primitive hexagonal unit cell of a P6 space group. For each COF, the c cell parameter was chosen through previously solved crystal structures for COF-5 and COF-10. Initially, these structures were estimated to be eclipsed and further optimized. First, a geometry optimization routine with coarse geometrical constraints was applied, followed by energy minimization with cell parameter flexibility using the parameters from the universal force field. Calculation of the simulated powder diffraction patterns and Pawley refinements were performed in the Materials Studio Reflex Plus Module using a Bragg-Brentano geometry. The intensity profile that matched most closely was used to refine. In the COFs reported here, eclipsed structures were found to be most consistent with the diffraction patterns. Crystallite size was estimated by the LeBail method, which was Pawley refined to the experimental data.

Electrical and Temperature Sensing Measurements. All electrical measurements were performed in ambient conditions on a probe station (Lakeshore) while connected to a Keithley 2400 source meter. Current-voltage (I-V) curves were collected between-40 V and 40 V on a hot plate regulated between 25-300° C. at 25° C. intervals.

Profilometry Measurements. All profilometry was performed using a Dektak 150 Stylus Surface Profiler. A stylus radius of 5 μm was applied at lengths of 1000 μm over a 300 sec duration (0.011 μm/sample resolution, stylus force=3.00 mg). Heights were obtained at two different positions on opposite sides of the printed film.

Grazing Incidence X-Ray Diffraction. In some instances, features corresponding to the substrate are observed at Q spaces greater than 1 Å⁻¹. Features indicated by “Au” belong to gold interdigitated electrodes.

Determination of Temperature Coefficient of Resistance (TCR). The temperature coefficient of resistance per degree of temperature change was calculated using Equation 1.

$$TCR = \frac{{R}_{f} - {R}_{i}}{{R}_{i} Δ T} \times 100 \qquad ( Equation 1 )$$

For COF-5-CNT and COF-10-CNT, R_{f}<<Rᵢ where Tᵢ is 25° C. and T_{f} is 300° C. Therefore, (R_{f}−Rᵢ)/Rᵢ approaches −1, and consequentially TCR is limited for large temperature ranges (ΔT). However, the resistance varies exponentially with temperature over the full range studied here (25-300° C.), resulting in a temperature-dependent TCR described by Equation 1. Thus, we also determine local TCR values per 1° C. steps. Because TCR can be thought of as

$$\frac{1}{{R}_{i}} \frac{dR}{dT} ,$$

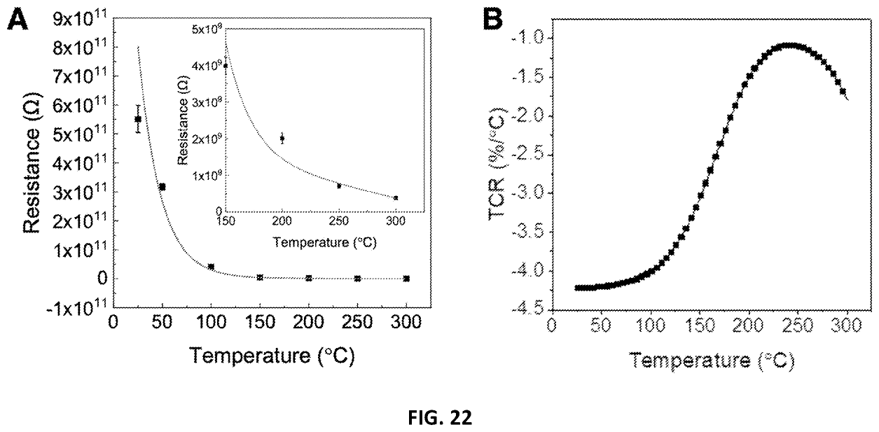

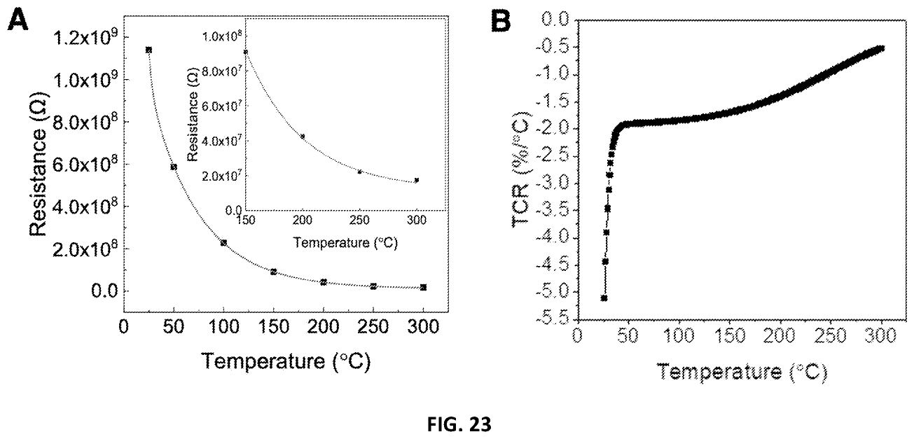

local TCRs were calculated by fitting the temperature-dependent resistance to an exponential function, determining local slopes at each temperature, and dividing by the resistance at the preceding 1° C. (FIG. 22, FIG. 23, Table 1).

TABLE 1
Local temperature coefficient of resistance (TCR) calculated
at each 1 °C interval for a COF-5-CNT sensor using exponential
fitting in FIG. 22 and a COF-10-CNT sensor using exponential
fitting in FIG. 23. Standard errors are calculated using the
standard deviation of local TCRs determined at each 1 °C
interval across the entire 25-300 °C temperature range.

| Temperature | COF-5 Local TCRs | COF-10 Local TCRs |
|---|---|---|
| (°C) | (% °C⁻¹) | (% °C⁻¹) |
| 25 | N/A | N/A |
| 50 | −4.2 ± 0.9 | −1.9 ± 0.4 |
| 75 | −4.1 ± 0.9 | −1.9 ± 0.4 |
| 100 | −4.0 ± 0.9 | −1.8 ± 0.4 |
| 125 | −3.7 ± 0.9 | −1.8 ± 0.3 |
| 150 | −3.1 ± 0.7 | −1.7 ± 0.3 |
| 175 | −2.2 ± 0.5 | −1.6 ± 0.3 |
| 200 | −1.5 ± 0.4 | −1.4 ± 0.2 |
| 225 | −1.1 ± 0.3 | −1.2 ± 0.2 |
| 250 | −1.1 ± 0.3 | −0.9 ± 0.2 |
| 275 | −1.3 ± 0.3 | −0.7 ± 0.1 |
| 300 | −1.8 ± 0.4 | −0.5 ± 0.1 |
| Average | −2.6 ± 0.6 | −1.4 ± 0.3 |

Additionally, sensor performance can be characterized using the temperature resistance ratio (TRR) using Equation 2 with representative calculations below:

$$TRR = \frac{{R}_{f}}{{R}_{i} Δ T} \times 100 \qquad ( Equation 2 )$$

### COF-5:

Ω₁ (25° C.)=5.43e11 Ω,
Ω₂ (300° C.)=1.16e8 Ω,
100×(5.43e11Ω)/(1.16e8Ω)/(275° C.))=1702%/° C.

### COF-10:

Ω₁ (25° C.)=1.14e9 Ω,
Ω₂ (300° C.)=1.69e7 Ω,
100×(1.14e9Ω)/(1.69e7Ω)/(275° C.)=24.5%/° C.

TABLE 2
Temperature ranges and temperature coefficient of resistance (TCR) for printed
COF-CNT materials compared to other CNT-polymer temperature sensors.

| Sensing Material | Range (°C) | Rᵢ(□) | R_{f}(□) | $\frac{{R}_{f}}{{R}_{i}}$ | TCR (% °C⁻¹) | TRR (% °C⁻¹) | Ref. |
|---|---|---|---|---|---|---|---|
| COF-5-CNT | 25-300 | 5.43 × 10¹¹ | 1.16 × 10⁸ | 4680 | −2.6† | 1702 | This |
| | | | | | | | Work |
| COF-10-CNT | 25-300 | 1.14 × 10⁹ | 1.69 × 10⁷ | 67.0 | −1.4† | 24.5 | This |
| | | | | | | | Work |
| MEH-PPV- | 20-50 | 4.1 × 10³ | 3.7 × 10³ | 1.1 | −0.28* | 3.6* | [4] |
| SWCNTs | | | | | | | |
| PMMA-butyl | 30-45 | 2.5 × 10³ | 2.2 × 10³ | 1.1 | −0.13 | 0.9* | [5] |
| carbide resin | | | | | | | |
| (2 wt % | | | | | | | |
| MWCNTS) | | | | | | | |
| PMMA-resin | 30-43 | 1.2 × 10⁵ | 1.06 × 10⁵ | 1.1 | −0.14 | 8.7* | [6] |
| (1 wt % MWCNTs) | | | | | | | |
| SEBS | 20-50 | not | not | — | −2.8 | 7.1* | [7] |
| (12.5 wt % | | reported | reported | | | | |
| MWCNTs) | | | | | | | |
| CMC | 0-80 | 8.2 × 10³ | 5.6 × 10³ | 1.5 | −0.29 | 1.8* | [8] |
| (0.03 wt % | | | | | | | |
| SWCNTs) | | | | | | | |
| GMSA-Hero-gum- | 22-91 | 3.4 × 10⁴ | 2.2 × 10⁴ | 1.4 | −0.74 | 2.4* | [9] |
| p-Si | | | | | | | |
| (20 wt% CNTs) | | | | | | | |

†TCRs calculated from the average of determined local TCRs (ΔT = 1 °C) in Table 1.
*calculated using Equation 1 or Equation 2 from reported data.

Determination of Relative Sensitivity. The relative sensitivity per degree of temperature change (%/° C., Equation 3) has been applied to a range of materials and allows direct, quantitative comparison through changes in resistance, conductivity, and voltage values. Calculations were performed over a temperature range of 25-300° C.

$$Relative Sensitivity = \frac{{σ}_{f}}{{σ}_{i} Δ T} \times 100 \qquad ( Equation 3 )$$

### COF-5:

σᵢ (25° C.)=3.90e-11 S/cm,
σ_{f} (300° C.)=2.08e-7 S/cm,
100×(2.08e-7 S/cm)/(3.90e-11 S/cm) (275° C.)=1940%/° C.

### COF-10:

σᵢ (25° C.)=2.70e-8 S/cm
σ_{f} (300° C.)=1.81e-6 S/cm
100×(1.81e-6 S/cm)/((2.70e-8 S/cm) (275° C.))=24.4%/° C.

TABLE 3
Ranges and relative sensitivities of COF materials using
ratiometric fluorescent and electrochemical sensors.

| | | | | Relative | | |
|---|---|---|---|---|---|---|
| Deposition | Sensing | | Range | Sensitivity | Absolute | |
| Method | Material | Substrate | (°C) | % °C⁻¹ | Sensitivity | Ref. |
| Aerosol Jet | COF-5-CNT | Kapton | 25-300 | 1940 | | This |
| Printing | | | | | | Work |
| Aerosol Jet | COF-10-CNT | Kapton | 25-300 | 24.4 | | This |
| Printing | | | | | | Work |
| powder | Tp-Bpy- | powder | −263-167 | 1.4^{\hat{ }} | | ^{[11]} |
| | Ln_acac | between | | | | |
| | | quartz plates | | | | |
| powder | TPB-DMTP- | pressed pellet | 100-130 | 4.80* | 0.012 | ^{[12]} |
| | COF | | | | S/cm °C | |
| Interfacial | Tp-DBA- | free-standing | 14-45 | 33* | 1.25 | ^{[13]} |
| polymerization | COF—COOH | membrane | | | mV/°C | |
| | membrane | | | | | |

^{\hat{ }}(employs ratiometric fluorescence analysis)
*calculated using Equation 3 using reported data.

### Results and Discussion

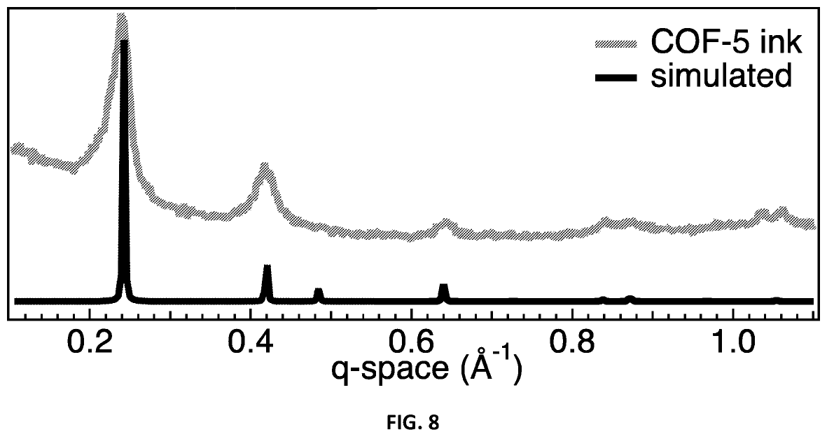

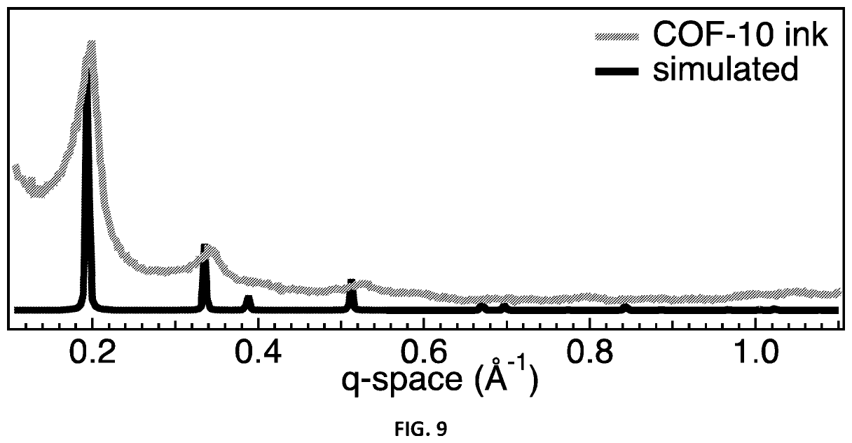

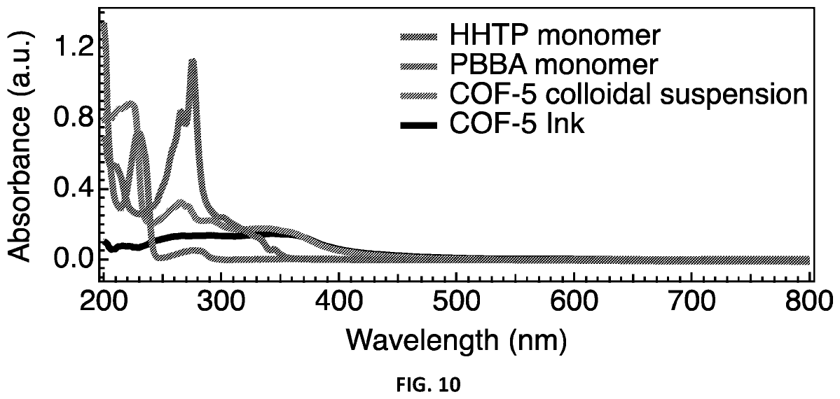

COF inks compatible with AJP were developed by modifying previously reported colloidal COF suspensions. Briefly, colloidal solutions of 2D boronate-ester COF nanoparticles were synthesized by combining the appropriate monomers in a 16:4:1 mixture of acetonitrile:1,4-dioxane:mesitylene. The resulting COFs were isolated and washed by centrifugation, after which the sedimented pellets were resuspended in acetonitrile (CH₃CN) to yield stable COF colloidal dispersions. Colloidal stability was retained for several days before the inks needed to be resuspended by brief bath sonication (<20 min). In solvo X-ray diffraction (XRD) confirmed high crystallinity of the COFs (FIGS. 8-9). The COF crystallites were also characterized by optical absorbance spectroscopy and compared to their monomeric counterparts (FIG. 10). The COF-5 absorption band is visible around 360 nm in the colloidal suspension and correlates to crystallite domain size. After ink formulation, bands correlating to unreacted monomer species decrease in intensity. Thus, ink formation improves COF purity and further reduces undesired monomer/oligomer byproducts in the printed films.

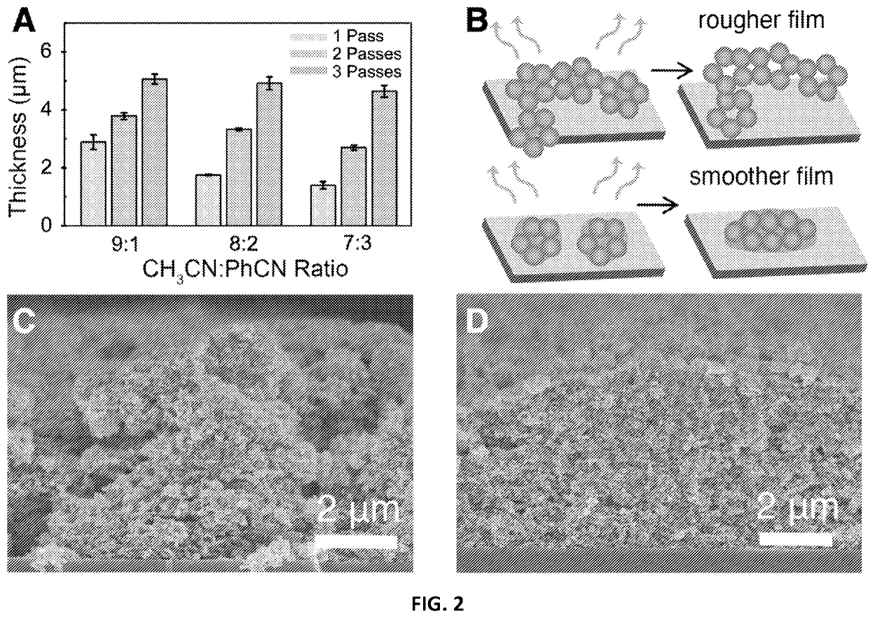

COF colloidal ink formulations were optimized for favorable printing conditions. During the initial attempt to print inks concentrated in pure CH₃CN, ink droplets could not be easily aerosolized by the atomizer due to the high volatility of CH₃CN. In response, the evaporation rate during ink atomization was controlled by adding lower volatility co-solvents, which is known to improve aerosolization while also reducing overspray in AJP. Benzonitrile proved to be the most effective low volatility co-solvent since it is chemically compatible with boronate-ester COFs and maintains COF colloidal stability. To find the optimal ratio of CH₃CN:PhCN, printed lines from inks of 9:1, 8:2, and 7:3 ratios were compared (panel A of FIG. 2).

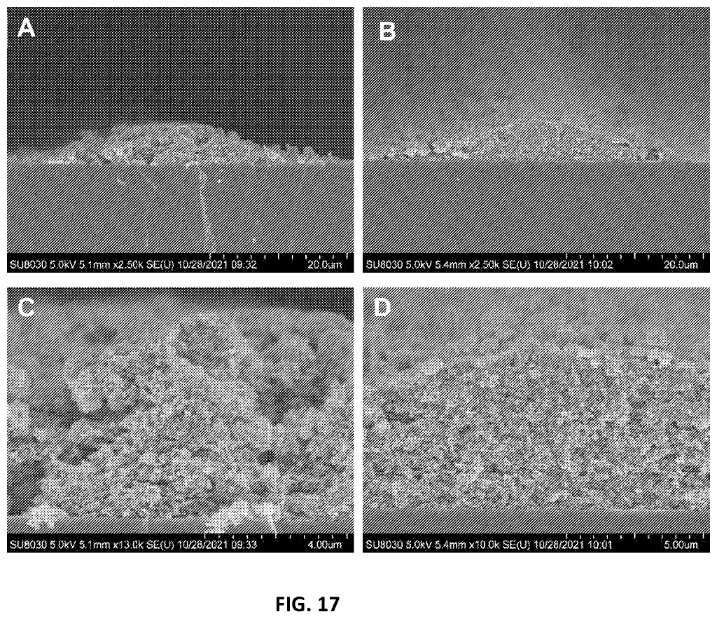

The addition of higher boiling point solvents impacts print morphology by influencing the solvent evaporation rate of ink droplets during printing and deposition. As ink droplets are carried by the transport gas, solvent evaporation leads to variation in the droplet size distribution that affects particle impaction during printing. In particular, uncontrollably fast solvent evaporation leads to suboptimal printing including increased overspray, reduced spatial resolution, and higher film roughness. When comparing the printed heights of 9:1, 8:2, and 7:3 CH₃CN:PhCN, the peak heights of printed layers for 9:1 CH₃CN:PhCN were found to be the tallest and also exhibited the greatest variation in the measured height (panel A of FIG. 2). Reduced levels of high boiling point solvent in the droplets lead to irregular stacking of deposited COF particles, while droplets with greater high boiling point solvent content allow for homogenous drying into more compact, uniform prints (panel B of FIG. 2). The amount of solvent present during AJP droplet deposition has been previously controlled by reducing the time of flight from the aerosolization chamber to the substrate and by increasing the percentage of low volatility co-solvent. Similarly, printing with lower percentages of PhCN (e.g., 9:1 CH₃CN:PhCN) produced rougher lines that appear as irregular colloidal aggregates (panel C of FIG. 2). These irregular colloidal aggregates result from the formation of ink droplets in the AJP process and subsequent evaporation of the solvent during transport to the substrate. Scanning electron microscopy (SEM) further provides insight into the observed thickness variations and confirms the influence of drying rate on morphology (panels C-D of FIG. 2 and FIG. 17). Cross-sectional SEM images for the 9:1 CH₃CN:PhCN ink formulation show irregular packing of colloidal particles, leading to inconsistent printing uniformity (panel C of FIG. 2). In contrast, cross-sectional SEM images for the 7:3 CH₃CN:PhCN ink formulation show homogenous packing of colloidal COFs into smoother, compact morphologies (panel D of FIG. 2). Therefore, the optimal 7:3 CH₃CN:PhCN COF ink formulation was used for the remainder of this study.

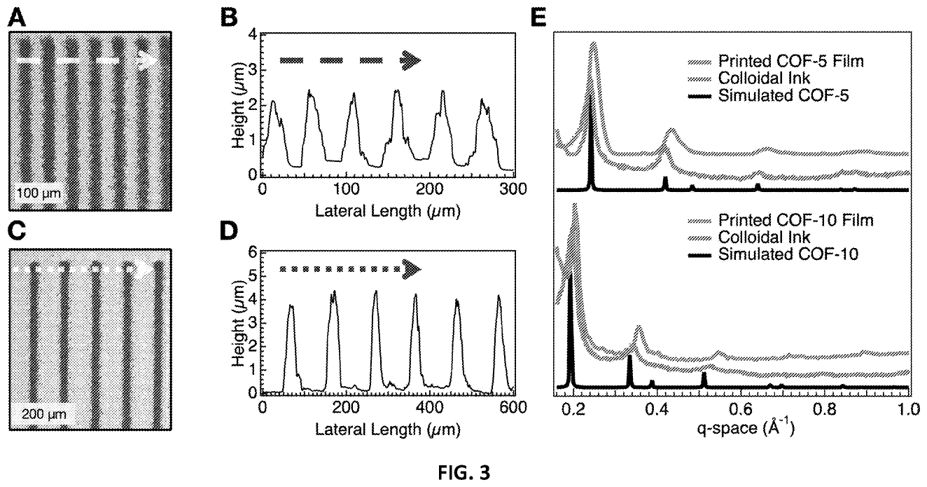

High lateral spatial resolution with limited overspray was achieved by controlling AJP flow rates and print speed. To optimize the ratio of sheath gas to carrier gas flow rates, inks were tested at 0.5 mm/sec print speed with carrier gas flow rates of 20, 30 and 40 cm³/min (sccm) while the sheath gas flow rate was held fixed at 50 sccm. Printed lines were assessed for both COF-5 and COF-10 inks (panels A-D of FIG. 3). Lower carrier gas flow rates of 20 and 30 sccm resulted in inhomogeneous coverage, whereas inks printed at 40 sccm showed more uniform coverage due to greater ink output and wetter deposition at higher flow rates. For both COF inks, optimized formulations, flow rates, and print parameters yielded lateral linewidth resolutions of 36±5 μm, which is suitable for many printed electronic device applications. We note that no additional post-processing or curing was necessary, which implies that these AJP COF films are compatible with a wide range of substrates including flexible, plastic substrates such as polyimide. Because traditional COF synthesis employs harsher organic solvents, heat, and acid catalysts, AJP of colloidal COFs enables their deposition on a wider range of substrates that are incompatible with typical COF polymerization conditions.

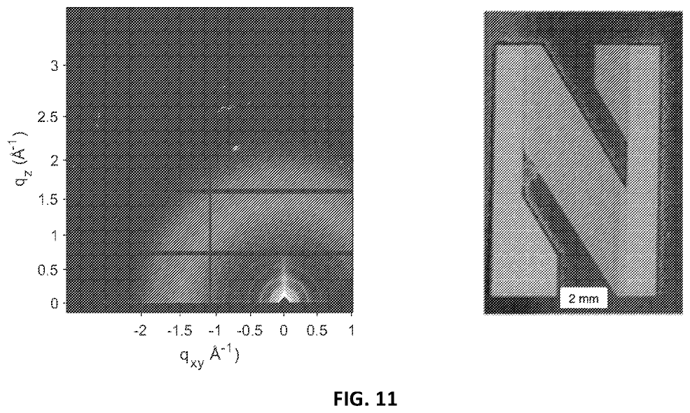

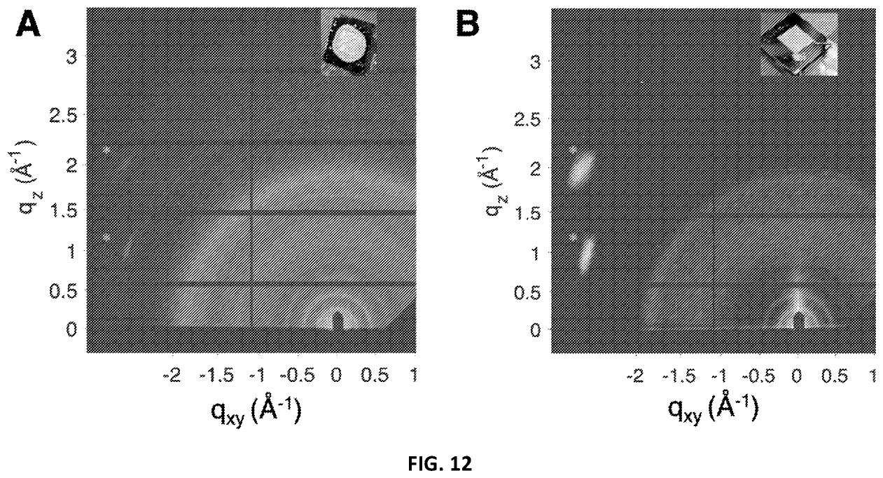

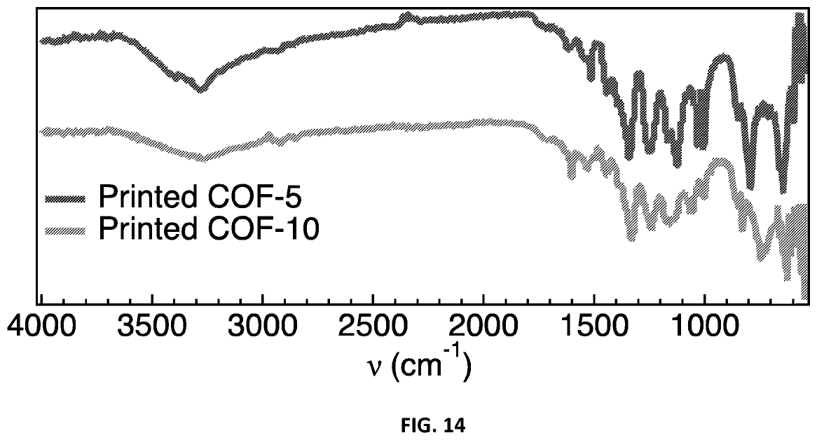

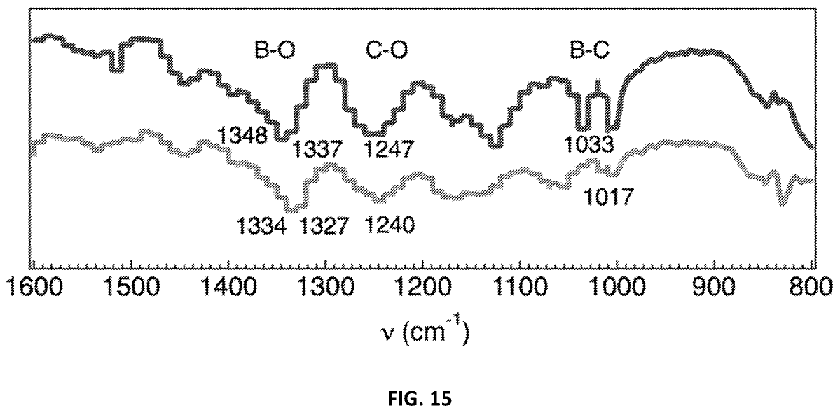

Homogenous, pinhole-free COF films were deposited at the wafer-scale while maintaining COF crystallinity. Inks of either COF-5 or COF-10 (7:3 CH₃CN:PhCN) were printed as squares or as designed shapes on silicon substrates (FIGS. 11-12). Grazing-incidence X-ray diffraction (XRD) of printed COF-5 and COF-10 films showed high in-plane crystallinity, matching in solvo capillary XRD of their colloidal ink counterparts (panel E of FIG. 3). Printed films of COF-5 show high in-plane crystallinity, exhibiting secondary peaks (110) at 0.41 Å⁻¹ and (200) at 0.48 Å⁻¹ as well as the primary (100) Bragg reflection indexed at 0.24 Å⁻¹, which matches those reported for COF-5. Printed films of COF-10 exhibit secondary peaks (110) at 0.33 Å⁻¹ and (200) at 0.38 Å⁻¹ as well as the primary (100) Bragg reflection indexed at 0.19 Å⁻¹. For both inks, these reflections are intense and unperturbed in inks containing 7:3 PhCN:CH₃CN or pure CH₃CN. The corresponding printed COF film and in solvo ink XRD patterns match well with their simulated structures. Additionally, the Fourier transform infrared (FTIR) spectra of the printed films retain bands corresponding to the boronate-ester rings for COF-5 and COF-10 (FIGS. 14-15). These results confirm that the crystallinity and chemical composition of the colloidal COFs are maintained throughout the ink formulation and AJP process.

To demonstrate the utility of the COF inks, the crystalline COF structures, which exhibit high thermal stabilities and in-plane thermal conductivities, were integrated into electrical-readout, all-printed temperature sensors. Since 2D boronate-ester COFs have large band gaps and are thus poor electrical conductors due to limited conjugation in the boronate ester bonds, carbon nanotubes (CNTs) were incorporated into the COF inks to enable COF-CNT nanocomposite films with improved electrical conductivity and temperature sensing responses. Previous work on CNT-polymer nanocomposite temperature sensors have employed poly [2-methoxy-5-(2′-ethylhexyloxy)-1,4-phenylene vinylene] (MEH-PPV), polymethyl(methacrylate) (PMMA), polystyrene-ethylene-butylene-styrene (SEBS), carboxy methyl cellulose (CMC), and related polymers. Although these prior CNT-polymer nanocomposites are temperature-sensitive, they have relatively narrow temperature ranges (ΔT<100° C.) and low upper threshold temperatures due to the relatively low thermal stabilities of the polymer components, thus presenting an opportunity for the higher thermal stability of COFs to achieve broader operating temperature ranges.

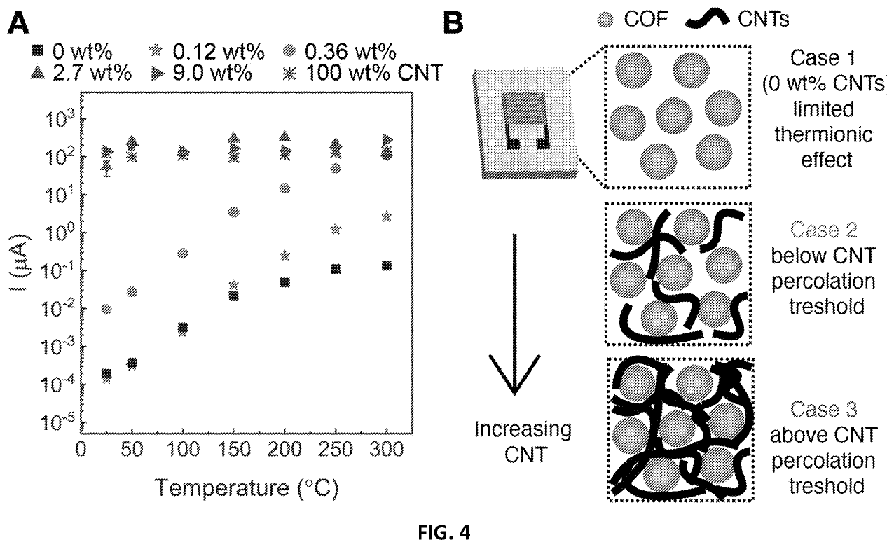

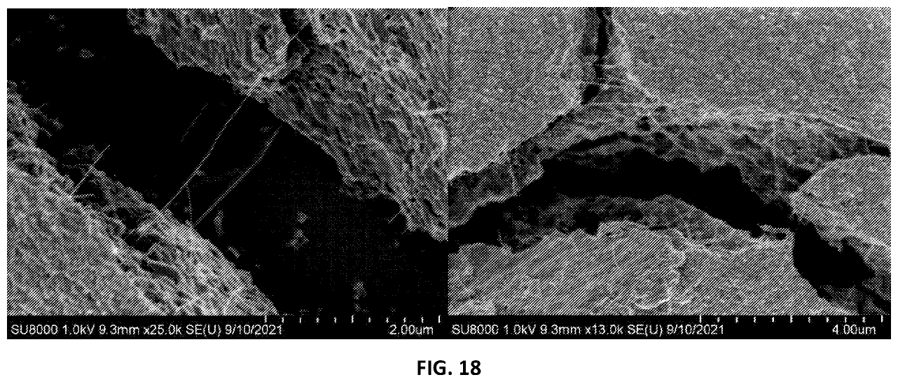

To determine the optimal CNT-COF nanocomposite composition for printed temperature sensors, the effect of CNT loading on the temperature-dependent electrical conductivity of CNT-COF nanocomposites was assessed. Inks including colloidal COF-5 with varying CNT content were screened by dropcasting on screen-printed graphene interdigitated electrodes (IDEs) on polyimide, after which the electrical conductivities of the resulting COF-CNT nanocomposite films were measured on a heated stage. The COF films without CNTs showed highly resistive charge transport that became more conductive with increasing temperature (panel A of FIG. 4). These results are consistent with previous observations of weak interlayer charge transport for COF-5. At temperatures above 250° C., the electrical conductivity of the COF-only film begins to saturate, whereas the addition of CNTs allows temperature-dependent charge transport to be extended over a broader temperature range (panel B of FIG. 4, case 1). The enhanced electrical signal can be explained by the CNTs acting as conductive bridges between COF crystallites, facilitating charge transport through the COF matrix (FIG. 18). The electrical conductivity of the COF-CNT nanocomposite films also strongly depends on the degree of CNT percolation. In particular, films with an intermediate level of CNT loading near the percolation threshold show up to four orders of magnitude change in electrical conductivity (panel B of FIG. 4, case 2). At high CNT loadings greater than 2.66 wt %, the CNTs form a continuous percolating network that maximizes current flow but also minimizes the effect of the COF matrix (panel B of FIG. 4, case 3). Since the CNTs themselves do not offer strong temperature sensing properties, the films with the highest CNT loadings above the percolation threshold are essentially insensitive to temperature changes, which is consistent with other reports of CNT-polymer nanocomposites. Overall, the optimal CNT loading in CNT-COF nanocomposite films for temperature sensing was determined to be 0.36 wt %.

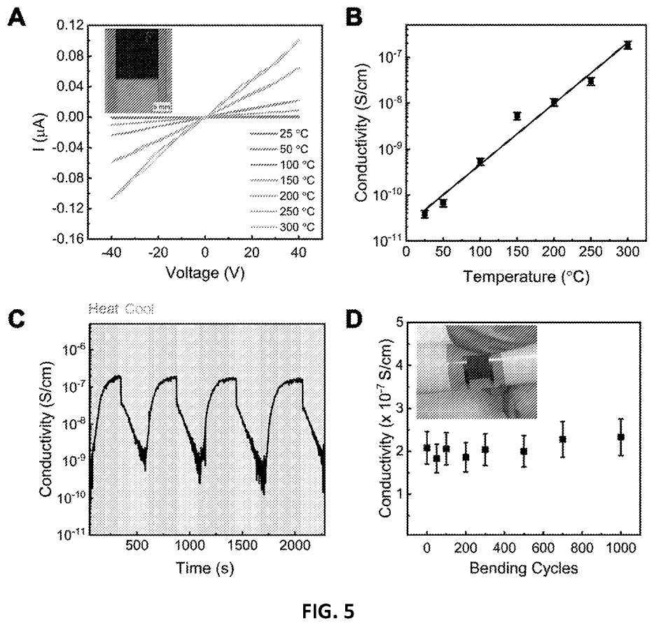

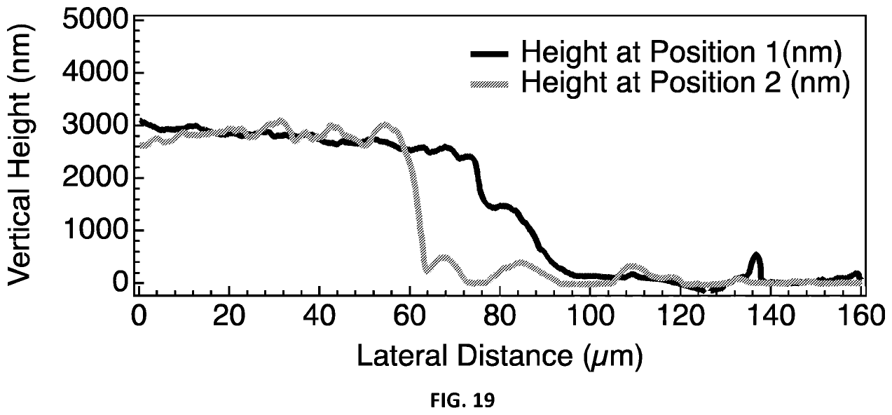

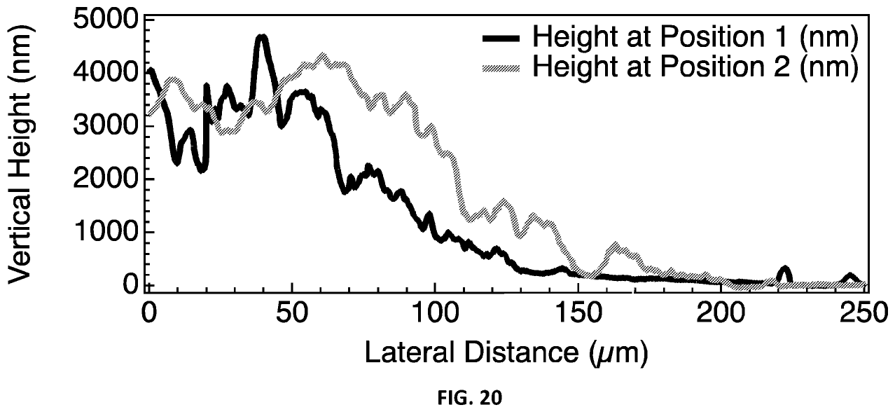

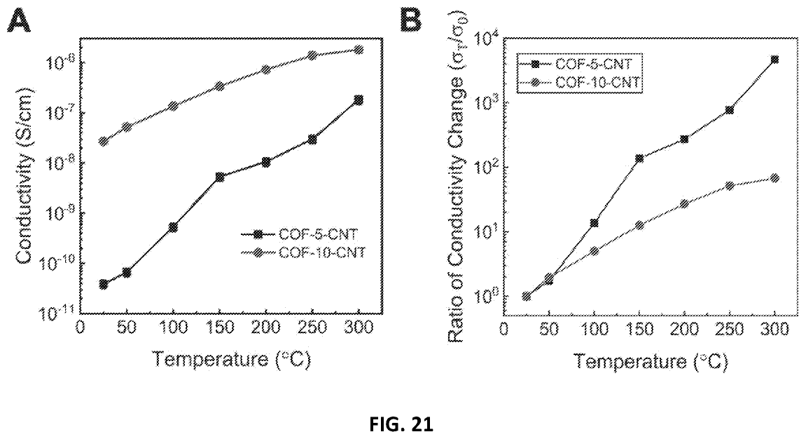

All-printed temperature sensors were fabricated by AJP of COF-CNT nanocomposite films on graphene IDEs on polyimide substrates. The thickness of the AJP films were approximately 3-4 μm (FIGS. 19-20). These devices show nearly 4 orders of magnitude increase in electrical conductivity over the temperature range of 25° C. to 300° C. (panels A-B of FIG. 5). Although poor ohmic behavior was observed at room temperature, linear ohmic charge transport was observed above 50° C., which is consistent with previous reports for semiconducting COFs. At the same CNT loading, COF-5-CNT nanocomposite devices showed higher temperature sensitivity than COF-10-CNT nanocomposite devices, likely due to their lower baseline electrical conductivity that results in a greater conductivity range across the assessed temperatures (FIG. 21).

Because the printed COF-CNT temperature sensors show exponential changes in electrical conductivity over a wide temperature range, their performance metrics must be carefully evaluated against other polymer and COF-based temperature sensors. Electrical-readout temperature sensors typically compare performance using the temperature coefficient of resistance (TCR) (Equation 1). Experimentally determined resistance values of the printed COF-CNT temperature sensors were fitted exponentially (panel A of FIG. 22 and panel A of FIG. 23). Local TCR values per 1° C. intervals at each temperature were calculated across the measured temperature range of 25° C. to 300° C. (panel B of FIG. 22, panel B of FIG. 23, Table 1). The printed COF-5-CNT and COF-10-CNT nanocomposite films show high local TCRs, which generally decrease in magnitude at higher temperatures as expected for exponential temperature dependence. For example, printed COF-5-CNT devices show a TCR of −4.2% ° C.⁻¹ for T=25-50° C. that decreases to −1.8% ° C.⁻¹ for T=275-300° C.⁻¹. Similarly, printed COF-10-CNT devices show a TCR response of −1.9% ° C.⁻¹ for T=25-50° C. that decreases to −0.5% ° C.⁻¹ for T=275-300° C. Even at the high temperature range that shows lower local TCR, the COF-CNT sensors exhibit competitive responses compared to other CNT-polymer temperature sensors (Table 4). We also calculated the temperature resistance ratio (TRR), which is another common temperature sensor metric (Table 4, Equation 2). COF-10-CNT and COF-5-CNT respectively yield TRR values of 24.5% ° C.⁻¹ and 1702% ° C.⁻¹, which are 3-180 times larger than the highest values calculated for other CNT-polymer temperature sensors (Table 4 and Table 2).

Furthermore, we determined the relative temperature sensitivity of the COF-CNT sensors in terms of conductivity change, which accounts for geometric factors. Across the temperature range of 25° C. to 300° C., the COF-5-CNT films possess a conductivity ratio (σ_{300° C.}/σ_{25° C.}) of nearly 10⁴, which translates into a percentage change in conductivity per degree of 1940% ° C.⁻¹ that also compares favorably against other COF-based temperature sensors (Table 3). Overall, using multiple performance metrics, our all-printed COF-CNT nanocomposite devices show higher temperature sensitivities and wider temperature ranges than previously reported CNT-polymer or COF-based temperature sensors.

TABLE 4
Temperature range, TCR, and TRR metrics for printed COF-CNT nanocomposites
compared to other CNT-polymer temperature sensors.

| Deposition | Sensing Material | Substrate | Range (°C) | Rᵢ(□) | $\frac{{R}_{f}}{{R}_{i}}$ | TCR (% °C⁻¹) | TRR (% °C⁻¹) | Ref. |
|---|---|---|---|---|---|---|---|---|
| Aerosol | COF-5-CNT | polyimide | 25-300 | 5.43 × 10¹¹ | 4680 | −2.6† | 1702 | This |
| Jet | | | | | | | | Work |
| Printing | | | | | | | | |
| Aerosol | COF-10-CNT | polyimide | 25-300 | 1.14 × 10⁹ | 67.0 | −1.4† | 24.5 | This |
| Jet | | | | | | | | Work |
| Printing | | | | | | | | |
| CVD and | SWCNTs - | flexible | 20-50 | 4.1 × 10³ | 1.1 | −0.28* | 3.6* | [52] |
| spin cast | MEH-PPV | polymeric | | | | | | |
| | polymer | substrate | | | | | | |
| Printing | PMMA-butyl | PVDF | 30-45 | 2.5 × 10³ | 1.1 | −0.13 | 0.9* | [53] |
| and dip- | carbide resin | mono- | | | | | | |
| coating | (2 wt % | filament | | | | | | |
| | MWCNTS) - | fiber | | | | | | |
| Screen- | PMMA-resin | polyimide | 30-43 | 1.2 × 10⁵ | 1.1 | −0.14 | 8.7* | [54] |
| Printing | (1 wt % | | | | | | | |
| | MWCNTs) | | | | | | | |
| Dropcasting | SEBS (12.5 | polyimide | 20-50 | not | — | −2.8 | 7.1* | [55] |
| | wt % | | | reported | | | | |
| | MWCNTs) | | | | | | | |
| Spraying | CMC | Si/SiO₂ | 0-80 | 8.2 × 10³ | 1.5 | −0.29 | 1.8* | [56] |
| | (0.03 wt % | | | | | | | |
| | SWCNTs) | | | | | | | |
| Dropcasting | GMSA-Hero- | Si/SiO₂ | 22-91 | 3.4 × 10⁴ | 1.4 | −0.74 | 2.4* | [57] |
| | gum-p-Si | (ion- | | | | | | |
| | (20 wt % | beam | | | | | | |
| | CNTs) | etched) | | | | | | |

†calculated using local TCRs determined at 1 ºC intervals across the entire temperature range at 40 V.
*calculated using Equation 1 or Equation 2 from reported data in Table 2.

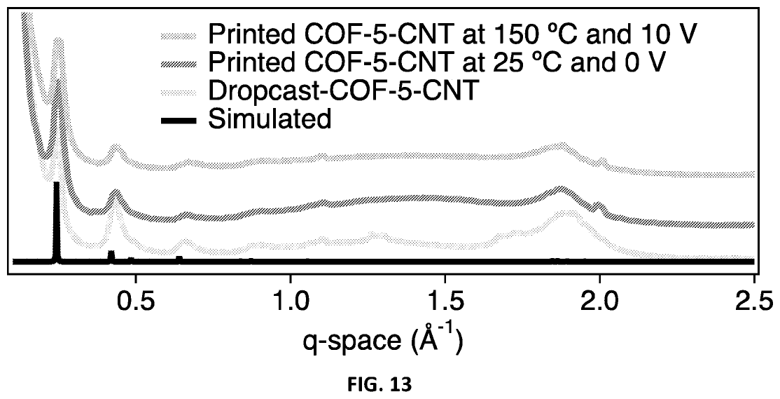

The all-printed COF-CNT temperature sensors also show reversible conductivities upon temperature cycling between room temperature and 300° C. (panel C of FIG. 5). For printed COF-5-CNT devices, an instantaneous and repeatable drop in conductivity occurs immediately upon removal from the heat source at 300° C., followed by a linear return to the room-temperature baseline conductivity within a few minutes. Upon returning the sensor to the heated surface at 300° C., the high-temperature conductivity is restored within seconds. These results confirm high robustness and temperature fidelity for the electrical readout for the all-printed COF-CNT devices. Structurally, these results suggest that applying voltages up to 40 V and temperatures up to 300° C. does not compromise the crystallinity of the COF matrix and thus the corresponding temperature sensing capabilities (FIG. 13). Although the synchrotron analysis chamber is limited to applied voltages of 10 V and temperatures of 150° C., in operando XRD further confirms that the in-plane crystallinity of the COFs is retained under these conditions. Additionally, the invariant COF crystallinity as a function of temperature rules out that the temperature response can be attributed to changes to the COF in-plane lattice. Finally, the mechanical robustness and resilience of the COF-CNT devices were confirmed through invariant conductivity measurements following 103 bending cycles at a radius of 12 mm (panel D of FIG. 5). These thermal and mechanical stabilities suggest that the COF-CNT nanocomposites can be deployed in a variety of settings including high-temperature environments and wearable devices.

### CONCLUSION

In summary, this invention discloses an ink formulation for solution-processed colloidal COFs that enable AJP of micron-scale patterned films. AJP broadens the additive manufacturing possibilities for COFs by providing compatibility with substrates that cannot tolerate solvothermal COF syntheses. The ink formulation is demonstrated for two boronate-ester COFs, which suggests that it can serve as an effective starting point for formulating inks for other boronate-ester and imine-based colloidal COFs. Using the same ink formulation, nanomaterials can be concurrently dispersed with colloidal COFs, which creates broad possibilities for printed COF nanocomposite films. As a proof-of-concept, boronate-ester COFs are combined with CNTs to tune the electrical conductivity and temperature sensitivity of the resulting printed nanocomposite films. When operating just below the CNT percolation threshold, these COF-CNT nanocomposite films show up to 4 orders of magnitude change in electrical conductivity from room temperature to 300° C., corresponding to higher temperature sensitivities and a wider operating temperature range than previously reported CNT-polymer or COF-based temperature sensors. Considering the modularity and chemical tailorability of COFs in addition to the diverse range of available nanomaterials, this work can serve as a springboard to a broad array of printed COF-based nanocomposite devices.

The foregoing description of the exemplary embodiments of the invention has been presented only for the purposes of illustration and description, and is not intended to be exhaustive or to limit the invention to the precise forms disclosed. Many modifications and variations are possible in light of the above teaching.

The embodiments were chosen and described to explain the principles of the invention and their practical application to enable others skilled in the art to utilize the invention and various embodiments and with various modifications suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications, and various publications, are cited and discussed in the description of this invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

### LIST OF REFERENCES

[1] N. Huang, P. Wang, D. Jiang, Nat. Rev. Mater. 2016, 1, 16068.
[2] D. Burmeister, M. G. Trunk, M. J. Bojdys, Chem. Soc. Rev. 2021, 50, 11559.
[3] B. Sun, C.-H. Zhu, Y. Liu, C. Wang, L.-J. Wan, D. Wang, Chem. Mater. 2017, 29, 4367.
[4] E. Jin, M. Asada, Q. Xu, S. Dalapati, M. A. Addicoat, M. A. Brady, H. Xu, T. Nakamura, T. Heine, Q. Chen, D. Jiang, Science 2017, 357, 673.
[5] S. Thomas, H. Li, R. R. Dasari, A. M. Evans, I. Castano, T. G. Allen, O. G. Reid, G. Rumbles, W. R. Dichtel, N. C. Gianneschi, S. R. Marder, V. Coropceanu, J.-L. Brédas, Mater. Horiz. 2019, 6, 1868.
[6] T. Li, H. Yu, Z. Xiong, Z. Gao, Y. Zhou, S.-T. Han, Mater. Horiz. 2021, 8, 2041.
[7] A. M. Evans, M. J. Strauss, A. R. Corcos, Z. Hirani, W. Ji, L. S. Hamachi, X. Aguilar-Enriquez, A. D. Chavez, B. J. Smith, W. R. Dichtel, Chem. Rev. 2022, 122, 442.
[8] S. Jhulki, A. M. Evans, X.-L. Hao, M. W. Cooper, C. H. Feriante, J. Leisen, H. Li, D. Lam, M. C. Hersam, S. Barlow, J.-L. Bredas, W. R. Dichtel, S. R. Marder, J. Am. Chem. Soc. 2020, 142, 783.
[9] A. McCreary, O. Kazakova, D. Jariwala, Z. Y. Al Balushi, 2D Mater. 2021, 8, 013001.
[10] A. M. Evans, A. Giri, V. K. Sangwan, S. Xun, M. Bartnof, C. G. Torres-Castanedo, H. B. Balch, M. S. Rahn, N. P. Bradshaw, E. Vitaku, D. W. Burke, H. Li, M. J. Bedzyk, F. Wang, J.-L. Bredas, J. A. Malen, A. J. H. McGaughey, M. C. Hersam, W. R. Dichtel, P. E. Hopkins, Nat. Mater. 2021, 20, 1142.
[11] A. M. Evans, M. R. Ryder, N. C. Flanders, E. Vitaku, L. X. Chen, W. R. Dichtel, Ind. Eng. Chem. Res. 2019, 58, 9883.
[12] E. Vitaku, C. N. Gannett, K. L. Carpenter, L. Shen, H. D. Abruna, W. R. Dichtel, J. Am. Chem. Soc. 2020, 142, 16.
[13] J. W. Colson, A. R. Woll, A. Mukherjee, M. P. Levendorf, E. L. Spitler, V. B. Shields, M. G. Spencer, J. Park, W. R. Dichtel, Science 2011, 332, 228.
[14] R. Matsuoka, R. Sakamoto, K. Hoshiko, S. Sasaki, H. Masunaga, K. Nagashio, H. Nishihara, J. Am. Chem. Soc. 2017, 139, 3145.
[15] M. F. Jimenez-Solomon, Q. Song, K. E. Jelfs, M. Munoz-Ibanez, A. G. Livingston, Nat. Mater. 2016, 15, 760.
[16] S. Karan, Z. Jiang, A. G. Livingston, Science 2015, 348, 1347.
[17] J. M. Rotter, S. Weinberger, J. Kampmann, T. Sick, M. Shalom, T. Bein, D. D. Medina, Chem. Mater. 2019, 31, 10008.
[18] R. P. Bisbey, C. R. DeBlase, B. J. Smith, W. R. Dichtel, J. Am. Chem. Soc. 2016, 138, 11433.
[19] A. Abrishamkar, D. Rodriguez-San-Miguel, J. A. Rodriguez Navarro, R. Rodriguez-Trujillo, D. B. Amabilino, R. Mas-Balleste, F. Zamora, A. J. deMello, J. Puigmarti-Luis, J. Vis. Exp. 2017, DOI: 10.3791/56020.
[20] D. Rodriguez-San-Miguel, A. Abrishamkar, J. A. Navarro, R. Rodriguez-Trujillo, D. B. Amabilino, R. Mas-Balleste, F. Zamora, J. Puigmarti-Luis, Chem. Commun. Camb. 2016, 52, 9212.
[21] M. Ratsch, C. Ye, Y. Yang, A. Zhang, A. M. Evans, K. Borjesson, J. Am. Chem. Soc. 2020, 142, 6548
[22] A. de la Pena Ruigomez, D. Rodriguez-San-Miguel, K. C. Stylianou, M. Cavallini, D. Gentili, F. Liscio, S. Milita, O. M. Roscioni, M. L. Ruiz-Gonzalez, C. Carbonell, D. Maspoch, R. Mas-Balleste, J. L. Segura, F. Zamora, Chemistry 2015, 21, 10666.
[23] M. Y. Teo, S. Kee, L. Stuart, J. Stringer, K. C. Aw, J. Mater. Chem. C 2021, 9, 12051.
[24] M. Zhang, L. Li, Q. Lin, M. Tang, Y. Wu, C. Ke, J. Am. Chem. Soc. 2019, 141, 5154.
[25] X. Liu, G. J. H. Lim, Y. Wang, L. Zhang, D. Mullangi, Y. Wu, D. Zhao, J. Ding, A. K. Cheetham, J. Wang, Chem. Eng. J. 2021, 403, 126333.
[26] C. Franco, D. Rodríguez-San-Miguel, A. Sorrenti, S. Sevim, R. Pons, A. E. Platero-Prats, M. Pavlovic, I. Szilágyi, M. L. Ruiz Gonzalez, J. M. González-Calbet, D. Bochicchio, L. Pesce, G. M. Pavan, I. Imaz, M. Cano-Sarabia, D. Maspoch, S. Pané, A. J. de Mello, F. Zamora, J. Puigmartí-Luis, J. Am. Chem. Soc. 2020, 142, 3540.
[27] J. Li, H. Rong, Y. Chen, H. Zhang, T. X. Liu, Y. Yuan, X. Zou, G. Zhu, Chem. Commun. 2020, 56, 6519.
[28] L. Yao, A. Rodríguez-Camargo, M. Xia, D. Mücke, R. Guntermann, Y. Liu, L. Grunenberg, A. Jiménez-Solano, S. T. Emmerling, V. Duppel, K. Sivula, T. Bein, H. Qi, U. Kaiser, M. Grätzel, B. V. Lotsch, J. Am. Chem. Soc. 2022, 144, 10291.
[29] G. Hu, J. Kang, L. W. T. Ng, X. Zhu, R. C. T. Howe, C. G. Jones, M. C. Hersam, T. Hasan, Chem. Soc. Rev. 2018, 47, 3265.
[30] M. Martínez-Fernández, R. Gavara, S. Royuela, L. Fernández-Ecija, J. Ignacio Martinez, F. Zamora, J. L. Segura, J. Mater. Chem. A 2022, 10, 4634.
[31] A. M. Evans, N. P. Bradshaw, B. Litchfield, M. J. Strauss, B. Seckman, M. R. Ryder, I. Castano, C. Gilmore, N. C. Gianneschi, C. R. Mulzer, M. C. Hersam, W. R. Dichtel, Adv. Mater. 2020, 32, 2004205.
[32] L. Kuo, V. K. Sangwan, S. V. Rangnekar, T.-C. Chu, D. Lam, Z. Zhu, L. J. Richter, R. Li, B. M. Szydłowska, J. R. Downing, B. J. Luijten, L. J. Lauhon, M. C. Hersam, Adv. Mater. 2022, 34, 2203772.
[33] M. Ha, J.-W. T. Seo, P. L. Prabhumirashi, W. Zhang, M. L. Geier, M. J. Renn, C. H. Kim, M. C. Hersam, C. D. Frisbie, Nano Lett. 2013, 13, 954.
[34] C. C. Pola, S. V. Rangnekar, R. Sheets, B. M. Szydłowska, J. R. Downing, K. W. Parate, S. G. Wallace, D. Tsai, M. C. Hersam, C. L. Gomes, J. C. Claussen, 2D Mater. 2022, 9, 035016.
[35] R. Kaindl, B. C. Bayer, T. Gupta, S. Pei, P. Hou, J. Du, C. Liu, W. Ren, A. Blümel, P. Patter, K. Popovic, D. Dergez, W. Waldhauser, Proceedings 2020, 56, 30.
[36] R. Kaindl, T. Gupta, A. Blumel, S. Pei, P.-X. Hou, J. Du, C. Liu, P. Patter, K. Popovic, D. Dergez, K. Elibol, E. Schafler, J. Liu, D. Eder, D. Kieslinger, W. Ren, P. Hartmann, W. Waldhauser, B. C. Bayer, ACS Omega 2021, 6, 34301.
[37] B. A. Williams, A. Mahajan, M. A. Smeaton, C. S. Holgate, E. S. Aydil, L. F. Francis, ACS Appl. Mater. Interfaces 2015, 7, 11526.
[38] W. Xie, X. Zhang, C. Leighton, C. D. Frisbie, Adv. Electron. Mater. 2017, 3, 1600369.
[39] F. Zare Bidoky, C. D. Frisbie, ACS Appl. Mater. Interfaces 2016, 8, 27012.
[40] N. J. Wilkinson, M. A. A. Smith, R. W. Kay, R. A. Harris, Int. J. Adv. Manuf. Technol. 2019, 105, 4599.
[41] E. B. Secor, Flex. Print. Electron. 2018, 3, 035007.
[42] C. H. Feriante, S. Jhulki, A. M. Evans, R. R. Dasari, K. Slicker, W. R. Dichtel, S. R. Marder, Adv. Mater. 2020, 32, 1905776.
[43] T. Sick, J. M. Rotter, S. Reuter, S. Kandambeth, N. N. Bach, M. Doblinger, J. Merz, T. Clark, T. B. Marder, T. Bein, D. D. Medina, J. Am. Chem. Soc. 2019, 141, 12570.
[44] B. J. Smith, L. R. Parent, A. C. Overholts, P. A. Beaucage, R. P. Bisbey, A. D. Chavez, N. Hwang, C. Park, A. M. Evans, N. C. Gianneschi, W. R. Dichtel, ACS Cent. Sci. 2017, 3, 58.
[45] N. C. Flanders, M. S. Kirschner, P. Kim, T. J. Fauvell, A. M. Evans, W. Helweh, A. P. Spencer, R. D. Schaller, W. R. Dichtel, L. X. Chen, J. Am. Chem. Soc. 2020, 142, 14957.
[46] A. Natraj, W. Ji, J. Xin, I. Castano, D. W. Burke, A. M. Evans, M. J. Strauss, M. Ateia, L. S. Hamachi, N. C. Gianneschi, Z. A. ALOthman, J. Sun, K. Yusuf, W. R. Dichtel, J. Am. Chem. Soc. 2022, 144, 19813.
[47] W. Ji, L. S. Hamachi, A. Natraj, N. C. Flanders, R. L. Li, L. X. Chen, W. R. Dichtel, Chem. Sci. 2021, 12, 16014.
[48] A. P. Côté, A. I. Benin, N. W. Ockwig, M. O'Keeffe, A. J. Matzger, O. M. Yaghi, Science 2005, 310, 1166.
[49] A. M. Evans, M. R. Ryder, W. Ji, M. J. Strauss, A. R. Corcos, E. Vitaku, N. C. Flanders, R. P. Bisbey, W. R. Dichtel, Faraday Discuss. 2021, 225, 226.
[50] M. Ikeda, M. Takeuchi, S. Shinkai, Chem. Commun. 2003, 1354.
[50] N. Huang, L. Zhai, D. E. Coupry, M. A. Addicoat, K. Okushita, K. Nishimura, T. Heine, D. Jiang, Nat. Commun. 2016, 7, 12325.
[51] I. N. Ivanov, D. B. Geohegan, Carbon Nanotube Temperature and Pressure Sensors, 2013, U.S. Pat. No. 8,568,027B2.
[53] M. Sibinski, M. Jakubowska, M. Sloma, Sensors 2010, 10, 7934.
[53] M. Sibiński, S. Walczak, Bull. Pol. Acad. Sci. Tech. Sci. 2014, 62, 759-763.
[55] G. Matzeu, A. Pucci, S. Savi, M. Romanelli, F. Di Francesco, Sens. Actuators Phys. 2012, 178, 94.
[55] E. Cagatay, A. Falco, A. Abdellah, P. Lugli, in 2014 10th Conf. PhD Res. Microelectron. Electron. PRIME (IEEE), 2014, pp. 1-4.
[56] M. T. S. Chani, A. M. Asiri, K. S. Karimov, M. Bashir, S. B. Khan, M. M. Rahman, Int. J. Electrochem. Sci. 2015, 10, 8.
[58] V. K. Sangwan, A. Behnam, V. W. Ballarotto, M. S. Fuhrer, A. Ural, E. D. Williams, Appl. Phys. Lett. 2010, 97, 043111.
[59] M. Žeželj, I. Stanković, Phys. Rev. B 2012, 86, 134202.
[60] H.-K. Jang, J. Eon Jin, J. Hee Choi, P.-S. Kang, D.-H. Kim, G. Tae Kim, Phys. Chem. Chem. Phys. 2015, 17, 6874.
[61] G. Bian, J. Yin, J. Zhu, Small 2021, 17, 2006043.
[62] A. M. Kaczmarek, Y.-Y. Liu, M. K. Kaczmarek, H. Liu, F. Artizzu, L. D. Carlos, P. Van Der Voort, Angew. Chem. 2020, 132, 1948.
[63] W. Xian, P. Zhang, C. Zhu, X. Zuo, S. Ma, Q. Sun, CCS Chem. 2021, 3, 2464.
[63] H. Xu, S. Tao, D. Jiang, Nat. Mater. 2016, 15, 722.
[64]. Studio, D., Accelrys Inc. San Diego, CA, USA, 2013.
[65]. A. M. Evans, L. R. Parent, N. C. Flanders, R. P. Bisbey, E. Vitaku, M. S. Kirschner, R. D. Schaller, L. X. Chen, N. C. Gianneschi, W. R. Dichtel, Science 2018, 361, 52.
[66]. S. Gong, Z. H. Zhu, Z. Li, Phys. Chem. Chem. Phys. 2017, 19, 5113.
[67]. I. N. Ivanov, D. B. Geohegan, Carbon Nanotube Temperature and Pressure Sensors, 2013, U.S. Pat. No. 8,568,027B2.
[68]. M. Sibinski, M. Jakubowska, M. Sloma, Sensors 2010, 10, 7934.
[69]. M. Sibiński, S. Walczak, Bull. Pol. Acad. Sci. Tech. Sci. 2014, 62, 759-763.
[70]. G. Matzeu, A. Pucci, S. Savi, M. Romanelli, F. Di Francesco, Sens. Actuators Phys. 2012, 178, 94.
[71]. E. Cagatay, A. Falco, A. Abdellah, P. Lugli, in 2014 10th Conf. PhD Res. Microelectron. Electron. PRIME (IEEE), 2014, pp. 1-4.
[72]. M. T. S. Chani, A. M. Asiri, K. S. Karimov, M. Bashir, S. B. Khan, M. M. Rahman, Int. J. Electrochem. Sci. 2015, 10, 8.
[73]. A. M. Kaczmarek, J. Liu, B. Laforce, L. Vincze, K. V. Hecke, R. V. Deun, Dalton Trans. 2017, 46, 5781.
[74]. A. M. Kaczmarek, Y.-Y. Liu, M. K. Kaczmarek, H. Liu, F. Artizzu, L. D. Carlos, P. Van Der Voort, Angew. Chem. 2020, 132, 1948.
[75]. H. Xu, S. Tao, D. Jiang, Nat. Mater. 2016, 15, 722.
[76]. P. Ruigomez, D. Rodriguez-San-Miguel, K. C. Stylianou, M. Cavallini, D. Gentili, F. Liscio, S. Militia, O. M. Roscioni, M. L. Ruiz-Gonzalez, C. Carbonell, D. Maspoch, R. Mas-Balleste, J. L. Segura, F. Zamora, Chem. Eur. 2015, 21, 10666.
[77]. K. Mohammed, S. Usgaonkar, F. Kanheerampockil, S. Karak, A. Halder, M. Tharkar, M. Addicoat, T. G. Ajithkumar, R. Banerjee, J. Am. Chem. Soc. 2020, 142, 8252.
[78]. D. Rodríguez-San-Miguel, F. Zamora, Chem. Soc. Rev. 2019, 48, 4375.
[79]. M. S. Lohse, T. Bein, Adv. Func. Mater. 2018, 28, 1705553.
[80]. X. Chen, K. Geng, R. Liu, K. T. Tan, Y. Gong, Z. Li, S. Tao, Q. Jiang, D. Jiang, Angew. Chem. Int. Ed. 2019.
[81]. E. B. Secor, T. Z. Gao, A. E. Islam, R. Rao, S. G. Wallace, J. Zhu, K. W. Putz, B. Maruyama, M. C. Hersam, Chem. Mater. 2017, 29, 2332.
[82]. Dongyang Zhu, Zhiqi Hu, Tanya K. Rogers, Morgan Barnes, Chia-Ping Tseng, Hao Mei, Lucas M. Sassi, Zhuqing Zhang, Muhammad M. Rahman, Pulickel M. Ajayan, and Rafael Verduzco, Chem. Mater. 2021 33, 6724-6730.
[83]. Yufeng Sun, Jingbo He, Geoffrey I. N. Waterhouse, Longhua Xu, Hongyan Zhang, Xuguang Qiao, Zhixiang Xu, Sensors and Actuators B: Chemical, 2019, 300, 126993.
[84]. W. Xian, P. Zhang, C. Zhu, X. Zuo, S. Ma, Q. Sun, CCS Chem. 2021, 3, 2464.
[85]. M. Lee, H. Shin, J. Lee, H. Kim, US20180090317, Mar. 29, 2018.
[86]. R. Banerjee, B. Garai, A. Mallick, WO2017025976A1, Feb. 16, 2017.
[87]. G. Y. Jung, H. Kim, U.S. Pat. No. 11,555,797B2, Jan. 17, 2023.
[88]. P. Karagiannidis, S. A. Hodge, A. C. Ferrari, F. Torrisi, U.S. Pat. No. 10,906,814B2, Feb. 2, 2021
[89]. F. Torrisi, T. Hasan, F. Bonaccorso, A. C. Ferrari, EP2909277B1, Sep. 4, 2019.
[90]. J. F. Federici, Y. Gu, A. Wu, U.S. Pat. No. 10,116,000B1, Oct. 30, 2018.
[91]. D. T. Britton, M. Harting, JP5806316B2, Sep. 11, 2015.
[92]. C. H. A. Rentrop, J. Sweelssen, M. Saalmink, E. C. P. Smits, W. A. Groen, TW201835945A, Dec. 1, 2022.
[93]. C. L. Bertin, T. Rueckes, B. M. Segal, J. W. Ward, CA2581058C, Dec. 14, 2016.

1. A colloidally stable ink, comprising:
one or more solvents; and
colloidal covalent organic frameworks (COFs) dispersed in the one or more solvents.

2. The ink of claim 1, wherein the COFs are boronate-ester COFs.

3. The ink of claim 2, wherein the boronate-ester COFs comprise hexahydroxytriphenylene paired with 1,4-phenylenebisboronic acid (COF-5), 4,4′-biphenyldiboronic acid (COF-10), pyrene-2,7-bisboronic acid (TP-COF), 4,4′-diphenylbutadiynebis(boronic acid) (DPB-COF), or 2,1,3-benzothiadiazole-4,7-bisboronic acid (TZD-COF).

4. The ink of claim 1, wherein the COFs are imine-based colloidal COFs.

5. The ink of claim 4, wherein the imine-based colloidal COFs comprise 1,3,5-tris(4-aminophenyl)benzene (TAPB), 4,4′,4″,4′-(ethene-1,1,2,2)-tetrayl)tetraaniline (ETTA), or 1,3,6,8-tetrakis(4-aminophenyl)pyrene (Py) nodes combined with a polyaldehyde linker.

6. The ink of claim 5, wherein the imine-based colloidal COFs comprise TAPB-PDA-COF, TAPB-TFP-COF, and/or Py-COF.

7. The ink of claim 1, wherein the one or more solvents are compatible with the COFs.

8. The ink of claim 1, wherein the one or more solvents comprise acetonitrile (CH₃CN), dibutyl phthalate, ethyl lactate, and/or toluene.

9. The ink of claim 8, wherein the one or more solvents further comprise at least one low volatility co-solvent that is chemically compatible with the COFs and maintains colloidal stability of the COFs.

10. The ink of claim 9, wherein the at least one low volatility co-solvent comprises benzonitrile (PhCN), dibutyl phthalate, ethyl lactate, and/or toluene.

11. The ink of claim 10, wherein a v/v ratio of CH₃CN:PhCN is printed at ratios of about 9:1, 8:2, 7:3, and 6:4.

12. The ink of claim 11, wherein the ratio has an optimal ratio of about 7:3.

13. The ink of claim 1, further comprising:
one or more nanomaterials dispersed with colloidal COFs.

14. The ink of claim 13, wherein the one or more nanomaterials comprise at least one of:
carbon nanotubes (CNTs);
two-dimensional (2D) nanomaterials including graphene oxide, hexagonal boron nitride, and/or transition metal dichalcogenides;
one-dimensional (1D) nanomaterials including macrocycles and assembled nanotubes, and/or graphene ribbons; and
zero-dimensional (0D) nanomaterials including quantum dots.

15. The ink of claim 14, wherein a concentration of the CNTs in the ink is in a range of about 0.1-10 wt %.

16. The ink of claim 14, wherein the CNTs act as conductive bridges between COF crystallites, facilitating charge transport through the COF matrix.

17. The ink of claim 1, being compatible with aerosol jet printing (AJP).

18. A device, comprising:
at least one element formed of the ink according to claim 1 on a substrate.

19. The device of claim 18, wherein the device has high thermal stabilities and in-plane thermal conductivities.

20. The device of claim 18, wherein the device has electrical conductivity and temperature sensitivity that are tunable.

21. The device of claim 20, wherein, when operating just below a CNT percolation threshold, the device has about 4 orders of magnitude increase in the electrical conductivity over a temperature range from about 25° C. to about 300° C.

22. The device of claim 20, wherein the electrical conductivity depends on a CNT loading.

23. The device of claim 22, wherein an optimal value of the CNT loading in at least one element for temperature sensing is about 0.36 wt %.

24. The device of claim 22, wherein the electrical conductivity further depends on the degree of CNT percolation.

25. The device of claim 18, wherein the device is an all-printed temperature sensor.

26. The device of claim 18, wherein the all-printed temperature sensor comprises a COF-CNT nanocomposite film.

27. The device of claim 26, wherein the all-printed temperature sensor is fabricated by aerosol jet printing (AJP) of the COF-CNT nanocomposite film on the substrate.

28. The device of claim 26, wherein the COF-CNT nanocomposite film has a thickness in a range of about 1-6 μm.

29. The device of claim 26, wherein the device has a linear ohmic charge transport for temperatures above 50° C.

30. The device of claim 26, wherein the COF-CNT nanocomposite film is a COF-5-CNT nanocomposite film or a COF-10-CNT nanocomposite film, wherein, at the same CNT loading, the COF-5-CNT nanocomposite film has a temperature sensitivity higher than that of the COF-10-CNT nanocomposite film.

31. The device of claim 26, wherein the all-printed temperature sensor has high local temperature coefficient of resistances (TCRs), which decrease in magnitude at higher temperatures as expected for exponential temperature dependence.

32. The device of claim 31, wherein the all-printed COF-10-CNT and COF-5-CNT temperature sensors yield temperature resistance ratio (TRR) values of about 24.5% ° C.⁻¹ and about 1702% ° C.⁻¹, respectively, which are about 3-180 times larger than the highest values for a CNT-polymer temperature sensor.

33. The device of claim 26, wherein the all-printed temperature sensor has exponential changes in the electrical conductivity over a wide temperature range.

34. The device of claim 33, wherein across the temperature range of about 25° C. to about 300° C., the COF-5-CNT temperature sensor has a conductivity ratio (σ_{300° C.}/σ_{25° C.}) of about 10⁴, which is corresponding to a percentage change in conductivity per degree of about 1940% ° C.⁻¹.

35. The device of claim 26, wherein the all-printed COF-CNT nanocomposite device has higher temperature sensitivities and wider temperature ranges than that of a CNT-polymer temperature sensor or a COF-based temperature sensor.

36. The device of claim 26, wherein the all-printed COF-CNT temperature sensors have reversible conductivities upon temperature cycling between room temperature and about 300° C.

37. The device of claim 36, wherein the printed COF-5-CNT device is configured such that an instantaneous and repeatable drop in conductivity occurs immediately upon removal from a heat source at 300° C., followed by a linear return to the room-temperature baseline conductivity within a few minutes, and wherein upon returning the sensor to the heated surface at 300° C., the high-temperature conductivity is restored within seconds.

38. The device of claim 18, wherein the device is operable in high-temperature environments.

39. The device of claim 18, wherein the device is bendable.

40. The device of claim 18, wherein the device is wearable.

41. A method of forming a colloidally stable ink, comprising:
combining monomers in a mixture of acetonitrile, 1,4-dioxane, and mesitylene to form a monomer solution;
filtering and heating the monomer solution to result in covalent organic frameworks (COFs);
isolating and washing the resulted COFs by centrifugation to yield sedimented pellets of the COFs; and
resuspending the COFs in acetonitrile (CH₃CN), dibutyl phthalate, ethyl lactate, or toluene to yield a stable COF colloidal ink.

42. The method of claim 41, wherein the mixture has a v/v ratio of acetonitrile:1,4-dioxane:mesitylene being about 16:4:1.

43. The method of claim 41, wherein said combining the monomers in the mixture comprises dissolving and sonicating the monomers together in the mixture.

44. The method of claim 41, wherein said filtering and heating the monomer solution is performed without stirring at about 85° C. overnight.

45. The method of claim 41, wherein the monomers comprise 2,3,6,7,10,11-hexahydroxytriphenylene (HHTP), and a boronic acid including 1,4-phenylenediboronic acid (PBBA), 4,4′-biphenylenediboronic acid (BPBBA), pyrene-2,7-bisboronic acid (TP), 4,4-diphenylbutadiynebis(boronic acid) (DPB), and/or 2,1,3-benzothiadiazole-4,7-bisboronic acid (TZD).

46. The method of claim 41, further comprising:
optimizing the COF colloidal ink for favorable printing conditions.

47. The method of claim 46, wherein said optimizing the COF colloidal ink comprises adding one or more lower volatility co-solvents that chemically compatible with boronate-ester COFs and maintain COF colloidal stability, for controlling an evaporation rate during ink atomization.

48. The method of claim 47, wherein the one or more lower volatility co-solvents comprise benzonitrile (PhCN).

49. The method of claim 48, wherein a v/v ratio of CH₃CN:PhCN is printed at ratios of about 9:1, 8:2, 7:3, and 6:4.

50. The method of claim 49, wherein the ratio has an optimal ratio of about 7:3.

51. The method of claim 48, further comprising:
dispersing one or more nanomaterials in the COF colloidal ink.

52. The method of claim 51, wherein the one or more nanomaterials comprise at least of:
carbon nanotubes (CNTs);
two-dimensional (2D) nanomaterials including graphene oxide, hexagonal boron nitride, and/or transition metal dichalcogenides;
one-dimensional (1D) nanomaterials including macrocycles and assembled nanotubes, and/or graphene ribbons; and
zero-dimensional (0D) nanomaterials including quantum dots.

53. The method of claim 52, wherein a concentration of the CNTs in the COF colloidal ink is in a range of about 0.1-10 wt %.

54. The method of claim 41, being compatible with aerosol jet printing (AJP).

55. A method for additive manufacturing of a covalent organic framework (COF) device, comprising:
providing a COF colloidal ink; and
adding one or more nanomaterials in the COF colloidal ink to form a COF-nanomaterial colloidal ink; and
aerosol jet printing of the COF-nanomaterial colloidal ink on a substrate to form a COF-nanomaterial device.

56. The method of claim 55, wherein the one or more nanomaterials comprise at least one of:
carbon nanotubes (CNTs);
two-dimensional (2D) nanomaterials including graphene oxide, hexagonal boron nitride, and/or transition metal dichalcogenides;
one-dimensional (1D) nanomaterials including macrocycles and assembled nanotubes, and/or graphene ribbons; and
zero-dimensional (0D) nanomaterials including quantum dots.
